(19) United States
(12) Patent Application Publication
(10) Pub. No.: US 2024/0274015 A1
(43) Pub. Date: Aug. 15, 2024

(54) SYSTEMS AND METHODS FOR AN AUTONOMOUS CONVOY WITH LEADER VEHICLE

(71) Applicant: Robotic Research OpCo, LLC, Clarksburg, MD (US)

(72) Inventors: Joseph PUTNEY, Waterford, VA (US); Alberto LACAZE, Potomac, MD (US); Edward MOTTERN, Olney, MD (US); Anne SCHNEIDER, Gaithersburg, MD (US); Karl MURPHY, Cocoa Beach, FL (US)

(21) Appl. No.: 18/568,826

(22) PCT Filed: Jun. 14, 2022
(86) PCT No.: PCT/US22/33380

§ 371 Date: Dec. 10, 2023

Related U.S. Application Data
(60) Provisional application No. 63/210,136, filed on Jun. 14, 2021.

(51) Int. Cl. G08G 1/00; G01C 21/00; G05D 1/246; G05D 1/698

(52) U.S. Cl. CPC G08G 1/22; G01C 21/3822; G01C 21/3848; G05D 1/2462; G05D 1/6985; B60W 2552/35; B60W 2554/20; B60W 2556/40; B60W 2556/65

(57) ABSTRACT

A module for a leader vehicle of a convoy can have a suite of sensors, a communication system, and a controller. The sensor suite can have at least one feature sensor that detects features and/or terrain in an environment and at least one location sensor that determines a location of the leader vehicle. Via the sensor suite, the controller can detect features as the leader vehicle travels along a route through the environment as well as the route of the leader vehicle. The controller can build a map for at least part of the environment with the detected route therethrough. Data indicative of the map and the detected route can then be transmitted to one or more follower vehicles. In some embodiments, the leader vehicle is manually driven while the follower vehicles operate autonomously.

### CROSS-REFERENCE TO RELATED APPLICATION(S)

This application claims benefit of and priority under 35 U.S.C. § 119(e) to and is a non-provisional of U.S. Provisional Patent Application No. 63/210,136 filed on Jun. 14, 2021 and titled “Systems and Methods for Manned Leader Autonomous Convoys,” which is hereby incorporated by reference herein in its entirety.

### FIELD

The present disclosure relates generally to autonomous vehicles, and more particularly, to a convoy of autonomous vehicles with a leader vehicle, for example, a manned leader vehicle.

### BACKGROUND

Convoys of vehicles have been employed to provide various benefits such as safety (e.g., in military situations) and/or fuel savings. A convoy of autonomous vehicles, referred to as “platooning” (or “flocking”), is a modern version of the convoy that provides many of the same advantages in a manner that requires little or no human intervention. In many cases, autonomous convoys are capable of efficiencies that are not readily achieved by human drivers (e.g., automatic maintaining of close separation distances). In some cases, however, autonomous control of the entire convoy can be difficult, for example, in regions that differ from expected road conditions (e.g., in work zones, due to an accident, presence of first responders, construction, or maintenance equipment, etc.). Embodiments of the disclosed subject matter may address one or more of the above-noted problems and disadvantages, among other things.

### SUMMARY

Embodiments of the disclosed subject matter provide a convoy with a leader vehicle and one or more autonomous follower vehicles. In some embodiments, the leader vehicle is a manned leader vehicle. A convoy leader module can be mounted on and/or integrated with the leader vehicle. A suite of sensors of the convoy leader module can detect features (e.g., landmarks, road signs, buildings, trees, etc.) within the environment as well as a route driven by the leader vehicle through the environment. The convoy leader module can use the detected features and route to construct a map, which can be shared with the follower vehicles in the convoy. The follower vehicles can use the shared map to follow the leader vehicle along the route. The follower vehicles can have their own sensors that detect the features within the environment and can use the detected features to improve the route following. In some embodiments, the shared map can include information regarding an environmental aspect (e.g., a slip condition, roadway features, area susceptible to dust generation, etc.), and the follower vehicles can implement one or more remedial measures at or in advance of a location of that environmental aspect. Alternatively or additionally, in some embodiments, the convoy leader module can share a change in state (e.g., suspension setting, windshield wiper setting, traction control setting, vehicle lighting setting, etc.) and associated location, and the one or more follower vehicles can implement the same state when it reaches that location.

In one or more embodiments, a convoy system can comprise a convoy leader module. The convoy leader module can comprise a first suite of sensors, a first communication system, and a first controller. The first suite can comprise at least one feature sensor operable to detect features or terrain in an environment to be traversed by the leader vehicle and at least one location sensor operable to determine a location of the leader vehicle. The first communication system can be operable to transmit one or more signals between the leader vehicle and one or more follower vehicles in the convoy. The first controller can be operatively coupled to the first suite of sensors and the first communication system. The first controller can be configured to detect, via the at least one feature sensor, one or more features as the leader vehicle travels along a route through the environment and to detect, via the at least one location sensor, the route of the leader vehicle through the environment. The first controller can be further configured to build, based at least in part on the detected one or more features and the detected route, a map for at least part of the environment with the detected route therethrough. The first controller can also be configured to transmit, via the first communication system, first data indicative of the map and the detected route to the one or more follower vehicles in the convoy.

In one or more embodiments, a convoy can comprise a leader vehicle and a plurality of autonomous follower vehicles for following the leader vehicle in the convoy. The leader vehicle can comprise a first suite of sensors, a first communication system, and a first controller. The first suite can comprise at least one feature sensor operable to detect features or terrain in an environment to be traversed by the leader vehicle and at least one location sensor operable to determine a location of the leader vehicle. The first communication system can be operable to transmit one or more signals between the leader vehicle and one or more follower vehicles in the convoy. The first controller can be configured to detect, via the at least one feature sensor, one or more features as the leader vehicle travels along a route through the environment, and to detect, via the at least one location sensor, the route of the leader vehicle through the environment. The first controller can be further configured to build, based at least in part on the detected one or more features and the detected route, a map for at least part of the environment with the detected route therethrough, and to transmit, via the first communication system, first data indicative of the map and the detected route to the one or more follower vehicles in the convoy. Each autonomous follower vehicle can comprise a drive-by-wire kit, a second suite of sensors, a second communication system, and a second controller. The second communication system can be operable to transmit one or more signals between the plurality of autonomous follower vehicles, the leader vehicle, or both. The second controller can be configured to receive, via the second communication system, the first data, and to control, via the drive-by-wire kit, the respective autonomous follower vehicle to follow the route based at least in part on the first data.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Where applicable, some elements may be simplified or otherwise not illustrated in order to assist in the illustration and description of underlying features. For example, in some figures, some components have been illustrated using a partial or cutaway view in order to illustrate internal interaction of components. Throughout the figures, like reference numerals denote like elements. An understanding of embodiments described herein and many of the attendant advantages thereof may be readily obtained by reference to the following detailed description when considered with the accompanying drawings, wherein:

FIGS. 1A-1D depict travel of a convoy of vehicles led by a manned vehicle, according to one or more embodiments of the disclosed subject matter;

FIG. 2 is a simplified schematic diagram of a manned vehicle with a convoy leader module, according to one or more embodiments of the disclosed subject matter;

FIG. 3A is a simplified schematic diagram of an exemplary system configuration for a convoy leader module, according to one or more embodiments of the disclosed subject matter;

FIG. 3B is a simplified schematic diagram of an exemplary system configuration for a convoy follower module, according to one or more embodiments of the disclosed subject matter;

FIG. 3C depicts a generalized example of a computing environment in which the disclosed technologies may be implemented;

FIG. 4A is a process flow diagram of a method performed by a leader of an autonomous convoy, according to one or more embodiments of the disclosed subject matter; and

FIG. 4B is a process flow diagram of a method performed a follower in an autonomous convoy, according to one or more embodiments of the disclosed subject matter.

### DETAILED DESCRIPTION

### I. Introduction

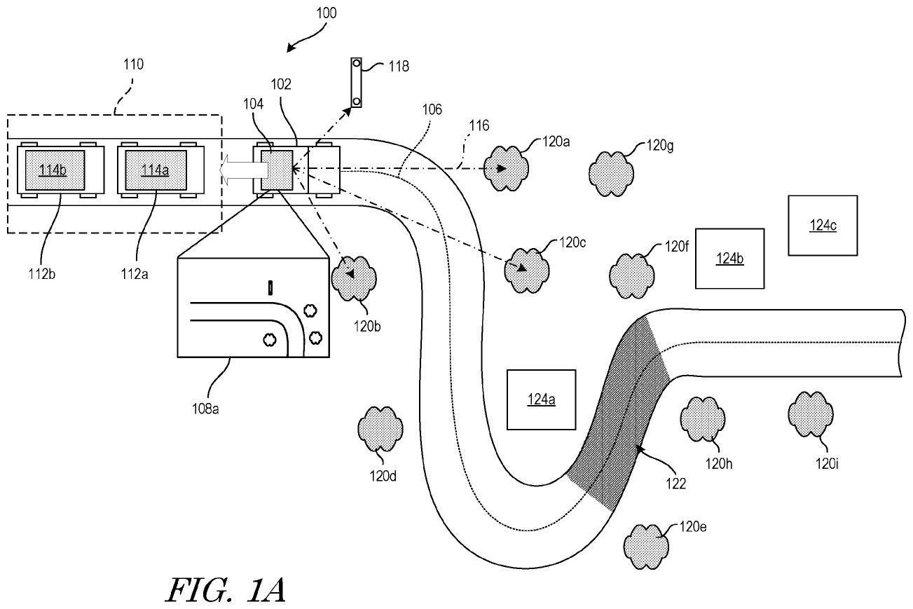

Referring to FIGS. 1A-1D, a convoy 100 can have a leader vehicle 102 and a set 110 of one or more followers. In the illustrated example, the set 110 of followers includes a first follower vehicle 112a and a second follower vehicle 112b; however, the set 110 of followers can include any number of vehicles, such as only one or at least three. In some embodiments, at least one vehicle 112 in the set 110 of followers is configured as an autonomous (e.g., fully autonomous or semi-autonomous) vehicle. For example, in some embodiments, each vehicle 112 in the set 110 of followers is an autonomous vehicle. In some embodiments, the leader vehicle 102 can be a manned vehicle (e.g., driven by a human operator).

The leader vehicle 102 can have a convoy leader module 104 mounted on and/or integrated with the leader vehicle 102. In some embodiments, the convoy leader module 104 can include one or more sensors for detecting features in the environment as well as location of the leader vehicle 102 as it is driven along a route 106 through the environment. For example, the convoy leader module 104 can detect one or more landmarks in the environment surrounding the leader vehicle 102, such as road sign 118, trees 120a-120i, and buildings 124a-124c. In the illustrated example of FIG. 1A, sensors of the convoy leader module 104 can have a field-of-view 116 is able to detect road sign 118 and trees 120a-120c. Although shown as extending in front of the leader vehicle 102, in some embodiments, the convoy leader module 104 can include sensors that monitor to the sides and rear of the vehicle 102 at the same time, for example, to provide a 360° field of view that monitors for features in the environment.

The convoy leader module 104 can use these detected features to build a map 108a that indicates the location of the detected features as well as the route 106 taken by the leader vehicle 102. For example, the map 108a can include location information regarding the detected features (e.g., road sign 118 and trees 120a-120c in FIG. 1A) in the environment. For example, the location information can include a minimum straight-line distance between the sensor and the feature when the vehicle is at a particular position along the route 106. Alternatively or additionally, the location information can include a distance along a direction perpendicular to route 106 (e.g., as illustrated schematically in FIGS. 1B-1D). The convoy leader module 104 can then periodically or continuously share the map 108a with the follower vehicles 112a, 112b, for example, by direct communication with the follower vehicles or by indirect communication (e.g., retransmission by an intermediate follower vehicle and/or via a communication network infrastructure, such as a cellular network).

In some embodiments, each of the follower vehicles 112a, 112b can have a respective convoy follower module 114a, 114b mounted on and/or integrated with the respective vehicle. Alternatively or additionally, in some embodiments, aspects of the described convoy follower module 114a, 114b may be parts of an existing autonomous driving system of the follower vehicle 112a, 112b. In some embodiments, the convoy follower module 114a of the first follower vehicle 112a can receive the map 108a directly or indirectly from the convoy leader module 104, and can use the information provided by the map 108a to follow the same route 106 (or substantially the same route 106, for example, with deviations allowed to avoid unexpected obstacles, such as pedestrians or moving vehicles) as the leader vehicle 102. For example, the convoy follower module 114a can independently detect the features in the environment (e.g., road sign 118 and trees 120a-120c in FIG. 1A) using one or more sensors. The convoy follower module 114a can compare the location of the detected features with the map 108a to improve its localization and/or its ability to follow route 106. For example, when the first follower vehicle 112a reaches the location previously occupied by the leader vehicle 102 in FIG. 1A, the first follower vehicle 112a can detect road sign 118 and trees 120a-120c and determine the respective distances to each and/or the location of each relative to route 106. If the location information determined by the first follower vehicle 112a differs from the corresponding location information in map 108a, the first follower vehicle 112a can adjust its trajectory to bring the location information for the detected features more in line with map 108a. In some embodiments, the feature detection and/or sharing can be similar to that described in U.S. Patent Application Publication No. 2020/0387169, published Dec. 10, 2020 and entitled “Feature Sharing in Autonomous Convoys,” which is hereby incorporated by reference herein.

In some embodiments, the use of detected features to improve follower operation may be helpful when satellite navigation systems are unavailable or prone to excessive error. However, follower operation may be improved even when satellite navigation systems are available, for example, to further improve the accuracy of route following. In some embodiments, a location accuracy (e.g., <1 m) offered by the feature-detection sensors of the convoy follower module 114a and/or the convoy leader module 104 can be better than the location accuracy (e.g., ˜1 m) offered by the satellite navigation system.

In some embodiments, second follower vehicle 112b (or subsequent follower vehicles) can receive the map 108a directly or indirectly from the convoy leader module 104. Alternatively, in some embodiments, the second follower vehicle 112b (or subsequent follower vehicles) can receive the map 108a directly or indirectly from an intervening follower vehicle (e.g., first follower vehicle 112a). In either case, the second follower vehicle 112b (or subsequent follower vehicles) can use the map 108a to improve route following, in a manner similar to that described for the first follower vehicle 112a.

As noted above, in some embodiments, the leader vehicle 102 can be manually operated (e.g., with a human driver). Accordingly, the convoy leader module 104 can be monitor the location of the leader vehicle 102 (e.g., based on distances to detected features, information from satellite navigation system, information from odometry systems, information from inertial measurement systems, etc.) as it is driven through the environment to define the route 106. As new features are detected along the route, the convoy leader module 104 can update the map and send the updated map to the follower set 110. For example, in FIG. 1B, the convoy leader module 104 is able to further detect tree 120d and building 124a, which is then added to map 108b for subsequent transmission to the follower set 110.

The manual operation of the leader vehicle 102 can be useful in certain scenarios where autonomous operation may be dangerous or deficient, such as but not limited to work zones, accident areas, detours from existing routes, weigh stations, areas with first responders (e.g., police, fire), areas with construction or maintenance equipment, unexpected or unannounced changes to infrastructure (e.g., highway ramp closure), non-standard or temporary signaling (e.g., hand signal direction by a police officer), areas where roadways are ill-defined or subject to variation (e.g., lacking demarcation), etc. For example, in some embodiments, a human driver may interact with the change of rules in ways that may beyond the state of the art for autonomous operation. Since the route driven by the manual operator may be safer in some cases, the safety of the convoy overall can be improved by having the follower vehicles autonomously follow the leader vehicle. In some embodiments, since the sensors on the leader vehicle can detect information prior to and share information with the follower vehicles, the convoy leader module can effectively extend the field-of-view of the sensors of the follower vehicles and/or allow the follower vehicles to implement remedial measures to address an environmental aspect.

Although the discussion above is directed to a human driver, in some embodiments, the driver can be located away from the leader vehicle, for example, in a remote station or in one of the follower vehicles in the convoy. Thus, in some embodiments, the human drive could control the leader vehicle via remote operation. Moreover, embodiments of the disclosed subject matter are not limited to a manned leader vehicle. Indeed, in some embodiments, the leader vehicle can be a fully autonomous or semi-autonomous vehicle. For example, the leader vehicle can be disengaged from autonomous operation in areas where manual operation may be desirable but may otherwise operate autonomously outside of such areas.

In some embodiments, in addition to or in place of feature detection, the convoy leader module 104 can be configured to detect an environmental aspect, for example, to classify the terrain and/or detect an aspect of the terrain that could impact operation of the follower vehicles. For example, in some embodiments, the convoy leader module 104 can detect a region 122 having an environmental aspect (e.g., a region of high slip and/or reduced traction, features in the terrain, dust generating area, roadway disturbances or disruptions, etc.). Sensors may be unable to accurately detect region 122 at a distance; rather, the vehicle may have to be positioned immediately before or within region 122 in order to accurately detect aspects thereof. Since leader vehicle 102 arrives at region 122 prior to any of the follower set 110, as shown in FIG. 1C, it can more readily detect aspects of region 122, which detected aspects can be shared with the follower set 110 via updated map 108c. In some embodiments, the follower vehicles 112a, 112b can implement remedial measures prior to or when arriving at region 122 to address the detected aspects. For example, in some embodiments, when a region of reduced traction (e.g., slip condition) is detected by the leader vehicle, the follower vehicles can maintain a speed (e.g., avoiding acceleration or deceleration) through the region, increase a separation distance between vehicles through the region, ignore certain sensor reading (e.g., wheel odometry or wheel encoder measurements) due to potential error, etc.

As the leader vehicle 102 continues to drive along route 106, convoy leader module 104 can continue to detect features and/or environmental aspects, generate an updated map, and share the updated map with the vehicles in the follower set 110. In the illustrated example of FIG. 1C, the convoy leader module 104 is able to further detect trees 120e-120h and buildings 124a-124b, which are then added to map 108c for subsequent transmission to the follower set 110. Similarly, in the illustrated example of FIG. 1D, the convoy leader module 104 is able to further detect trees 120i and building 124c, which are then added to map 108d for subsequent transmission to the follower set 110. In some embodiments, the updated map can be transmitted to the follower set 110 on a continuous or substantially continuous basis (e.g., on a periodic basis at ≤500 ms intervals). Alternatively or additionally, in some embodiments, the convoy leader module 104 can transmit to the follower set 110 changes and/or additions to a previously sent map. For example, instead of transmitting map 108b in FIG. 1B, the convoy leader module 104 can transmit the locations of tree 120d and building 124a, as well as location information defining the portion of the route 106 that the leader vehicle drives between FIGS. 1A-1B. The convoy follower modules 114a, 114b can then update map 108a previously received from the convoy leader module 104 to include the information regarding tree 120d, building 124a, and the portion of route 106.

### II. Convoy Modules

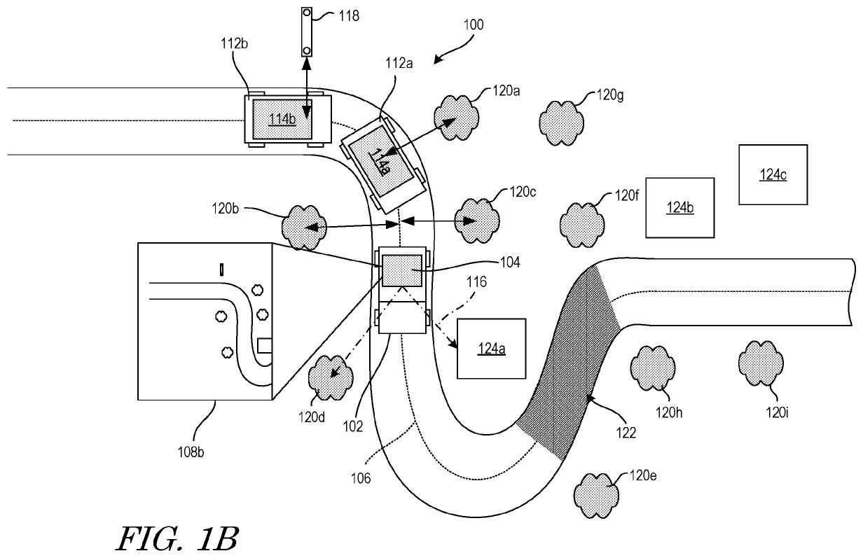

In some embodiments, a convoy leader module (CLM) can be configured as a modular unit 200 that can be attached to an exterior of a leader vehicle, such as truck 212 of tractor-trailer truck 210, as shown in FIG. 2. In the illustrated example of FIG. 2, the CLM unit 200 can be mounted on a roof of the truck 212. Alternatively or additionally, the CLM unit 200, or part thereof, can be mounted to a bumper or fender (e.g., as shown at location 200a), a gap between the tractor 212 and trailer 214 (e.g., as shown at location 200b), or a roof of the trailer 214 (e.g., as shown at location 200c). Other locations for the CLM unit 200, or part thereof, are also possible according to one or more contemplated embodiments, such as but not limited to a hood, a front license plate, a mirror, or inside a cab of the leader vehicle. Alternatively or additionally, in some embodiments, different parts of the CLM unit 200 can be mounted or attached to different portions of the leader vehicle. Alternatively, in some embodiments, the leader vehicle can be initially manufactured (e.g., factor installed) or modified after manufacture (e.g., after-market) to include various components of the CLM unit 200. In some embodiments, the CLM unit 200 can include a power storage device (e.g., a battery) and/or a power generation mechanism (e.g., a solar panel, a wind turbine, etc.). Alternatively or additionally, in some embodiments, the CLM unit 200 can be connected to an electrical system or battery of the leader vehicle so as to receive electrical power therefrom.

In some embodiments, the CLM unit 200 can include a suite of sensors 202, a communication system 204, a control system 206, and/or a data storage system 208. The suite of sensors 202 can be configured to detect features or terrain in the environment and/or location of the leader vehicle. For example, in some embodiments, the sensor suite can include one or more sensors for visualizing the surroundings, such as but not limited to electro-optic cameras, light detection and ranging (LIDAR) systems, radio detection and ranging (RADAR) systems, vehicle-to-everything (V2X) devices, or any combination thereof. In some embodiments, the sensor suite can also include one or more sensors for localization, such as but not limited to global navigation satellite system (GNSS) sensor (e.g., global positioning system (GPS)), an inertial measurement unit (IMU), a differential GNSS station, a dynamic base real-time kinematic (DRTK) device, an ultra-wideband (UWB) radio, a visual odometry device, a light detection and ranging (LIDAR) odometry system, a radio detection and ranging (RADAR) odometry system, or any combination of the foregoing.

In some embodiments, one or more sensors of the suite 202 can be mounted away from the remainder of CLM unit 200, for example, to monitor a particular component of the leader vehicle. For example, a strain gauge 218 or other sensor can be provided to monitor a wheel of the leader vehicle, as shown in FIG. 2. In some embodiments, each wheel can be provided with a strain gauge 218, for example, to monitor tire dynamics, tire deformation, and/or tractive effort performed by each wheel. Alternatively or additionally, in some embodiments, the CLM unit 200 can interface with an existing controller area network (CAN) bus 220, for example, to collect information regarding leader vehicle state. For example, CAN bus 220 can provide information regarding fuel economy, leader vehicle speed (e.g., via wheel odometry of the leader vehicle), steering column position, braking status (e.g., braking engaged, anti-lock braking system (ABS) activation, etc.), acceleration status, gear status, wiper activation, turn indicator activation, vehicle lighting (e.g., headlights) activation, suspension state, traction modality (e.g., traction control engaged), etc.

In some embodiments, one or more sensors of the suite 202 (or an existing sensor within the cabin of the leader vehicle) can be configured to monitor the movements and/or attention of a human driver of the leader vehicle. For example, such sensors can include an eye tracking sensor, a driver seat occupancy sensor, a steering wheel contact sensor, a pedal contact sensor, or any combination thereof. In some embodiments, the control system 206 can be configured to alert the human driver based on signals from the one or more sensors (e.g., to alert an inattentive driver) and/or to transmit the alert to the follower vehicles (e.g., which may take a remedial measure in case the leader driven route is not optimal or is unsafe due to the inattentive driver). Alternatively or additionally, in some embodiments, the control system 206 can convey information regarding the human driver to the follower vehicles, for example, to use the eye tracking of the driver to guide the sensor suite of the follower vehicles. In some embodiments, the control system 206 can provide one or more driver assistance functions, for example, by alerting the human driver of a hazardous condition, such as but not limited to an environmental aspect (e.g., reduced traction area), lane departure, or imminent collision.

In some embodiments, the sensor suite 202 can be configured to detect features (e.g., landmarks that can be used to localize a vehicle) and their position with respect to a trajectory of the leader vehicle. The control system 206 can use the detected features to create a map of the environment, for example, including information regarding static objects, moving objects, lane markings, road width, road signs, road grade, road conditions, hazards, and/or environmental aspects. For example, the road conditions and/or environmental aspects can include information regarding traction (e.g., friction coefficient, rolling resistance, slip condition, etc.), terrain deformation, topology (e.g., road crown, washboard, washout, pothole, sinkhole, puddle, mud), etc. In some embodiments, the map can further include information regarding the state of the leader vehicle, for example, from CAN bus 220, as noted above. In some embodiments, storage system 208 can store a priori information (e.g., speed limit, road network, rules of the road, feature locations, road signs, etc.), and control system 206 can use the stored information to complement and/or enhance the data sensed by sensor suite 202.

In some embodiments, the control system 206 can be configured to store the map (e.g., as an archived map for use by other convoys or for reuse when the leader vehicles travels through the same region) and/or store information regarding operation of the leader vehicle, for example, in data storage system 208. For example, the control system 206 can be configured to record performance and/or safety of the driver of the lead vehicle and/or of the follower vehicles in the convoy. Alternatively or additionally, information regarding safety incidents (e.g., braking exceeding a predetermined threshold, collision, and/or driving and other regulatory infractions) can be recorded in the data storage system 208. Alternatively or additionally, the control system 206 can send information regarding operation of the leader vehicle and/or the follower vehicles via communication system 204. For example, the control system 206 can send telemetry information to a remote monitoring system (e.g., a fleet control station). In some embodiments, telemetry information can include but is not limited to fuel consumption, fuel level, battery state of charge, vehicle location, vehicle trajectory, elevation, vehicle speed, vehicle pitch, vehicle identifier, number of vehicles in convoy, and cargo carried by vehicles.

In some embodiments, a user interface (UI) 216 can be provided within the cabin of the leader vehicle, for example, to allow the human driver therein to interact with CLM unit 200. For example, the UI 216 can allow the driver to set a driving modality, order of follower vehicles, and/or following/separation distance for one or more of the follower vehicles, which settings can then be communicated to the convoy via communication system 204. Alternatively or additionally, in some embodiments, the human driver in the lead vehicle can use UI 216 to issue commands (e.g., relayed via communication system 204) to one or more of the follower vehicles, for example, to perform an autonomous maneuver, such as but not limited to parking, docking, stopping, driving along an indicated route, and/or driving to a specified location. Alternatively or additionally, in some embodiments, the UI 216 can allow the human driver to monitor the convoy, for example, by providing an indication of the status and/or health of one or more of the follower vehicles.

In some embodiments, the communication system can comprise a radio that communicates to the follower vehicles (e.g., vehicle-to-vehicle (V2V) communication) and/or communicates to infrastructure (e.g., vehicle-to-infrastructure (V2I) communication). Alternatively or additionally, in some embodiments, the communication system can be configured to communicate with the follower vehicles without having a line-of-sight to any of the follower vehicles, for example, using Wi-Fi, cellular service, satellite communications, or any combination of the foregoing. Alternatively or additionally, the communication system can be configured to communicate with the follower vehicles using infrared (IR) signals, electro-optical signals, LIDAR signals, or UWB signals.

In some embodiments, the follower vehicles can use the map and other information from CLM unit 200 to autonomously follow a route driven by the leader vehicle. In some embodiments, the follower vehicles can use a combination of the data provided by the CLM unit 200 and a-priori data (e.g., rules of the road, existing road network information, etc.) in planning to autonomously follow the route driven by the leader vehicle. Alternatively or additionally, the follower vehicles can use a combination of the data provided by the CLM unit 200 and independent detection of the leader vehicle via its own sensor suite in planning to autonomously follow the route driven by the leader vehicle. For example, in some embodiments, the CLM unit 200 can include fiducial markings that can be imaged by one or more of the follower vehicles to complement and/or enhance detection of the leader vehicle.

Although the leader vehicle in FIG. 2 is illustrated as a tractor-trailer truck 210, embodiments of the disclosed subject matter are not limited thereto. Indeed, in some embodiments, the leader vehicle can comprise a truck, a bus, a shuttle (e.g., van, etc.), a car, an aircraft (e.g., plane, helicopter, drone, etc.), a mining or construction vehicle (e.g., dump truck, etc.), an agricultural vehicle (e.g., tractor, etc.), a warehouse vehicle (e.g., forklift, hostler, etc.), or any other mode of transportation, as well as combinations thereof. In some embodiments, at least one of the follower vehicles (e.g., one, some, or all of the follower vehicles) can be the same as the leader vehicle (e.g., same size, same type, same make, same model, etc.). Alternatively, in some embodiments, the leader vehicle can be different than at least one of the follower vehicles (e.g., one, some, or all of the follower vehicles). For example, the leader vehicle can be a car or a truck without a trailer, while the follower vehicles can be tractor-trailer trucks. Other variations are also possible according to one or more contemplated embodiments.

Although not shown, in some embodiments, one, some, or all of the follower vehicles can have a convoy follower module that is mounted in a manner similar to that as CLM unit 200 in FIG. 2. For example, in some embodiments, each follower vehicle can have a convoy follower module (CFM) configured as a modular unit and attached to an exterior of the follower vehicle, such as but not limited to, a roof, a bumper or fender, a hood, a front license plate, a mirror, a cab, or a trailer of the follower vehicle. Alternatively, in some embodiments, one, some, or all of the follower vehicles can be initially manufactured (e.g., factor installed) or modified after manufacture (e.g., after-market) to include various components of the CFM unit.

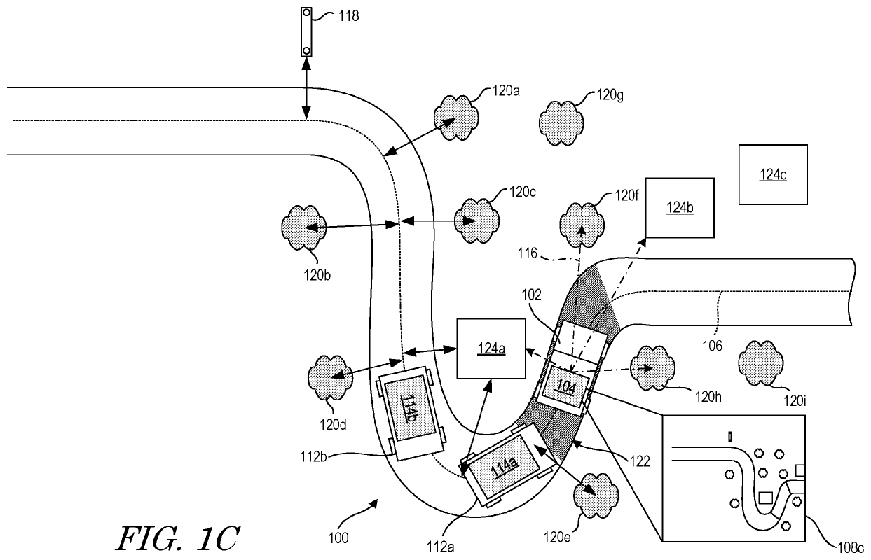

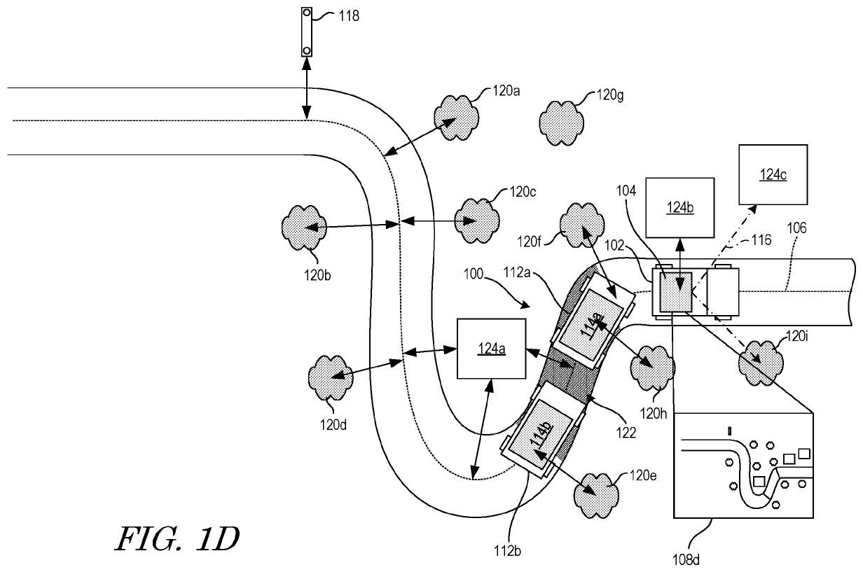

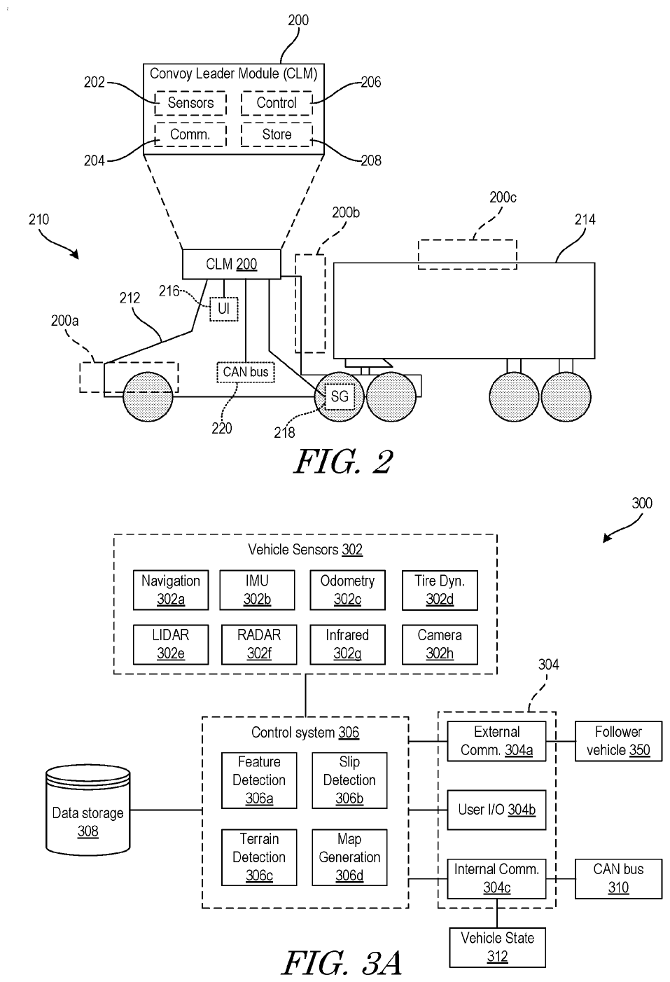

FIG. 3A illustrates an exemplary configuration of a convoy leader module (CLM) 300, which can be mounted on or integrated with a leader vehicle (e.g., a manned leader vehicle) of a convoy. In the illustrated example, the CLM 300 can include a control system 306, a suite 302 of sensors, a communication system 304, and one or more memories or databases (e.g., database 308). In some embodiments, the sensor suite 302 can include a navigation sensor 302a (e.g., a global navigation satellite system (GNSS), etc.), an inertial measurement unit (IMU) 302b, an odometry system 302c, a tire sensor 302d, a light detection and ranging (LIDAR) system 302e, a radio detection and ranging (RADAR) system 302f, an infrared (IR) imager 302g, a visual camera 302h, or any combination thereof. Other sensors are also possible according to one or more contemplated embodiments. For example, sensor suite 320 can further include an ultrasonic or acoustic sensor for detecting distance or proximity to objects, a compass to measure heading, inclinometer to measure an inclination of the leader vehicle, or any combination thereof.

In some embodiments, the navigation sensor 302a can be used to determine relative or absolute position of the leader vehicle. In some embodiments, IMU 302b can be used to determine orientation or position of the leader vehicle. For example, the IMU 302b can comprise one or more gyroscopes or accelerometers, such as a microelectromechanical system (MEMS) gyroscope or MEMS accelerometer. In some embodiments, the odometry sensor 302c can detect a change in position of the leader vehicle over time (e.g., distance). In some embodiments, odometry sensors 302c can be provided for one, some, or all of wheels of the leader vehicle, for example, to measure corresponding wheel speed, rotation, and/or revolutions per unit time, which measurements can then be correlated to change in position of the leader vehicle. Alternatively or additionally, in some embodiments, the data from the odometry sensors 302c can be used to assess for a slip condition and/or lack of traction. For example, the odometry sensor 302c can include an encoder, a Hall effect sensor measuring speed, or any combination thereof.

In some embodiments, the tire sensor 302d can measure tire dynamics, tire deformation, and/or tractive effort. In some embodiments, the tire sensor 302d can be provided for one, some, or all of wheels of the leader vehicle. For example, the tire sensor can include a load cell, strain gauge, pressure sensor, or any other transducer capable of measuring force or changes therein. In some embodiments, the LIDAR system 302e can use light illumination (e.g., structured light or laser) to measure distances to obstacles or features within an environment surrounding the leader vehicle. In some embodiments, the LIDAR system 302e can be configured to provide three-dimensional imaging data of the environment, and the imaging data can be processed (e.g., by the LIDAR system itself or by a module of control system 306) to generate a 360-degree view of the environment. For example, the LIDAR system 302e can include an illumination light source (e.g., laser or laser diode), an optical assembly for directing light to/from the system (e.g., one or more static or moving mirrors (such as a rotating mirror), phased arrays, lens, filters, etc.), and a photodetector (e.g., a solid-state photodiode or photomultiplier). In some embodiments, the RADAR system 302f can use irradiation with radio frequency waves to detect obstacles or features within an environment surrounding the leader vehicle. In some embodiment, the RADAR system 302f can be configured to detect a distance, position, and/or movement vector of an obstacle or feature within the environment. For example, the RADAR system 302f can include a transmitter that generates electromagnetic waves (e.g., radio frequency or microwaves), and a receiver that detects electromagnetic waves reflected back from the environment.

In some embodiments, the IR sensor 302g can detect infrared radiation from an environment surrounding the leader vehicle. In some embodiments, the IR sensor 302g can detect obstacles or features in low-light level or dark conditions, for example, by including an IR light source (e.g., IR light-emitting diode (LED)) for illuminating the surrounding environment. Alternatively or additionally, in some embodiments, the IR sensor 302g can be configured to measure temperature based on detected IR radiation, for example, to assist in classifying a detected feature or obstacle as a person or vehicle. In some embodiments, the camera sensor 302h (e.g., EO camera) can detect visible light radiation from the environment, for example, to determine obstacles or features within the environment. For example, the camera sensor 302h can include an imaging sensor array (e.g., a charge-coupled device (CCD) or complementary metal-oxide semiconductor (CMOS) sensor) and associated optic assembly for directing light onto a detection surface of the sensor array (e.g., lenses, filters, mirrors, etc.). In some embodiments, multiple camera sensors 302h can be provided in a stereo configuration, for example, to provide depth measurements.

The sensor suite 302 can be operatively coupled to the control system 306, such that the control system 306 can receive data signals from the sensors 302a-302h and generate responsively thereto an environment map and/or route information for use by the follower vehicles. In some embodiments, the control system 306 includes one or more modules. For example, the control system 306 can include a feature detection module 306a, a slip detection module 306b, a terrain detection or classification module 306c, and/or a map generation module 306d.

In some embodiments, the feature detection module 306a can be configured to detect one or more features (e.g., moving objects and/or stationary objects, such as trees, road signs, buildings, etc.) in the environment. In some embodiments, the feature detection can include determining a relative location (e.g., one or more distances to the feature from the leader vehicle at one or more points along the route, one or more headings or orientations at which the feature is detected with respect to a trajectory of the leader vehicle, one or more distances between the feature and the route followed by the leader vehicle, etc.), an absolute location (e.g., derived GPS coordinates based on the detected location of the features and the location of the leader vehicle as determined by the navigation system, etc.), or combinations thereof. In some embodiments, the feature detection module 306a can select one, some, or all of the detected features for inclusion in the map to be sent to the follower vehicles. For example, in some embodiments, the feature detection module 306a can select larger-size and/or more readily-detectable features (e.g., large trees, buildings, road signs, etc.) for inclusion in the map, while ignoring or disregarding smaller-size and/or less readily-detectable features (e.g., small bushes, fire hydrants, etc.). Alternatively or additionally, the feature detection module 306a can select substantially stationary features for inclusion in the map, while ignoring or disregarding moving features (e.g., pedestrians, other vehicles, etc.).

In some embodiments, the slip detection module 306b can be configured to determine a slip condition and a location of a slip condition. In some embodiments, the slip detection module 306b can determine that the leader vehicle is experiencing a slip condition or loss of traction by looking for variations in signals from different sensors (e.g., redundant sensors or sensors that provide overlapping or related information). For example, the slip detection module 306b can compare signals from wheel odometry sensors with signals from the navigation sensors or other position-detecting devices (e.g., LIDAR or Doppler RADAR for landmark navigation), where a difference between the sensors can indicate a slip condition. For example, when the wheel odometry sensor indicates that the leader vehicle has traveled a first distance but the navigation sensor indicates that the leader vehicle has traveled a second distance less than the first distance, then the slip detection module 306b can indicate a slip condition. Alternatively or additionally, the slip detection module 306b can compare signals from encoders on different wheels of the leader vehicle, where a difference between the sensors can indicate one of the wheels is experiencing a slip condition. Other mechanisms for measuring slip conditions are also possible according to one or more contemplated embodiments. In some embodiments, the slip detection module 306b can identify the slip condition and a location of the slip condition, and this information can be transmitted to the follower vehicles as part of the generated map.

In some embodiments, the terrain detection module 306c can be configured to recognize the terrain of the environment to be traversed and/or traversed by the leader vehicle. In some embodiments, the terrain detection module 306c can classify the terrain based on signals from one or more visualization sensors, for example, LIDAR system 302e, RADAR system 302f, IR sensor 302g, and/or camera 302h. In some embodiments, the terrain detection module 306c can employ a-priori information (e.g., stored in data storage device 308), for example, expected terrain for particular locations. In some embodiments, the terrain detection module 306c can identify an environmental aspect (e.g., an area of reduced visibility, a dust cloud, an area susceptible to dust production, road crown, roadway corrugation (washboard), roadway washout, pothole, sinkhole, deformable features in roadway, puddle, mud, etc.) and a location thereof. Alternatively or additionally, in some embodiments, the terrain detection module 306c can use signals from sensors that measure acceleration and/or force (e.g., strain gauge, accelerometer, etc.) to identify an environmental aspect. Alternatively or additionally, in some embodiments, the terrain detection module 306c can compare signals from different sensors to identify an environmental aspect. For example, signals from the LIDAR system and/or camera could image a puddle as a solid support surface but another sensor on the leader vehicle would measure vertical displacement of the wheel as it moves into the puddle. In some embodiments, the terrain detection module 306c can detect the puddle as an environmental aspect based on these different sensor assessments. Other mechanisms for detecting environmental aspects are also possible according to one or more contemplated embodiments. In some embodiments, the terrain detection module 306c can characterize the terrain including one or more environmental aspects and locations thereof, and this information can be transmitted to the follower vehicles as part of the generated map.

In some embodiments, the map generation module 306d can be configured to detect a route driven by the leader vehicle through the environment, for example, based on signals from one or more localization sensors (e.g., navigation sensor 302a, IMU, 302b, odometry 302c, LIDAR 302e, RADAR 302f, IR sensor 302g, and/or camera 302h). The map generation module 306d can generate a map that includes the route driven by the leader vehicle, for transmission to the other vehicles in the convoy to follow. Alternatively or additionally, the map generation module 306d can be configured to compile the information from the feature detection module 306a, the slip detection module 306b, and/or the terrain detection module 306c for inclusion in and/or transmission with the generated map. For example, in some embodiments, the map can include information about detected environmental aspects and locations thereof, information regarding the terrain, and/or information regarding slip conditions and locations thereof. In some embodiments, the generated map is partly or fully in the form of data as opposed to forming a graphical illustration (e.g., 108a-108d in FIGS. 1A-1D). In some embodiments, the generated map can be stored in data storage 308, for example, for later use (e.g., when driving through the same environment at a later time) and/or subsequent transmission (e.g., when the map is only sent to the follower vehicles during periodic transmission windows).

Alternatively or additionally, in some embodiments, the map generation module 306d can receive information regarding an operational state (e.g., setting of a vehicle suspension, setting of a braking system (e.g., anti-lock braking system on or off), setting of a traction modality, activation of vehicle lighting, activation of windshield wipers, etc.), for example, from a vehicle state monitoring system 312 of the leader vehicle via internal communication system 304c. In some embodiments, the operational state may be manually selected by the driver of the leader vehicle, for example, to accommodate changing road and/or weather conditions. Alternatively or additionally, in some embodiments, the map generation module 306d can receive information regarding vehicle status (e.g., vehicle speed, steering position, brake status, acceleration status, gear status, wiper status, turn signal indicator status, vehicle lighting status, etc.), for example, from CAN bus 310 of the leader vehicle via internal communication system 304c. In some embodiments, the map can include information about the detected operational state and/or vehicle status, as well as corresponding locations thereof.

In some embodiments, a user interface 304b can be configured to receive input from a human operator and/or provide feedback (e.g., tactile, visual, auditory, etc.) to the human operator regarding operation of the leader vehicle and/or follower vehicles in the convoy. For example, the input can comprise motion (e.g., touchscreen interface, manipulation of a joystick, toggle of switch, etc.), audio (e.g., voice commands), or both. In some embodiments, the user interface 304b can be used to control operation of the convoy or constituent vehicles thereof, for example, via respective modules of control system 306 and/or overriding commands issued by modules of control system 306. In some embodiments, the user interface 304b can be configured as a remote workstation for teleoperation of the leader vehicle.

In some embodiments, communication between the convoy follower module (CFM) 350 and the CLM 300 can be provided via an external communication system 304a. In some embodiments, communication via the external communication system 304a can be encrypted. For example, in some embodiments, external communication system 304a can comprise a radio that communicates to the follower vehicles (e.g., vehicle-to-vehicle (V2V) communication) and/or communicates to infrastructure (e.g., vehicle-to-infrastructure (V2I) communication). Alternatively or additionally, in some embodiments, the communication system 304a can be configured to communicate without having a line-of-sight to any of the follower vehicles, for example, using Wi-Fi, Bluetooth, cellular service (e.g., cellular vehicle-to-everything (C-V2X) communication), and/or satellite communications. Alternatively or additionally, the communication system 304a can be configured to communicate with the follower vehicles using IR signals, EO signals, LIDAR signals, or UWB signals.

FIG. 3B illustrates an exemplary configuration of a convoy follower module (CFM) 350, which can be mounted on or integrated with at least one follower vehicle (e.g., autonomous follower vehicle) of a convoy. In the illustrated example, the CFM 350 can include a control system 356, a suite 352 of sensors, a communication system 354, and one or more memories or databases (e.g., a leader map storage 358a, a rules of the road database 358b, and/or a road network database 358c). In some embodiments, the sensor suite 352 can include a navigation sensor 352a (e.g., GNSS, etc.), an IMU 352b, an odometry system 352c, a tire sensor 352d, a LIDAR system 352e, a RADAR system 352f, an IR imager 352g, a visual camera 352h, or any combination thereof. Other sensors are also possible according to one or more contemplated embodiments. The configuration of sensors 352a-352h in suite 352 may be substantially similar to that of sensors 302a-302h in suite 302 of CLM 300 described above.

The sensor suite 352 can be operatively coupled to the control system 356, such that the control system 356 can receive data signals from the sensors 352a-352h and autonomously control operation of the follower vehicle responsively thereto. In some embodiments, the control system 356 includes one or more modules. For example, the control system 356 can include a map processing module 356a, a route planning module 356b, an obstacle detection module 356c, a drive control module 356d, and/or a vehicle state control module 356e.

In some embodiments, the map processing module 356a can be configured to receive the map from the CLM 300, for example, via external communication system 354a. For example, the map processing module 356a can process the map to extract the route driven by the leader vehicle and to be followed by the follower vehicle. In some embodiments, information regarding localization features, environmental aspects (e.g., regions of slip), terrain, operational state of the leader vehicle, and/or vehicle status of the leader vehicle can be extracted from the received map. In some embodiments, the map processing module 356a can store the received map and/or information extracted therefrom, for example, in leader map storage 358a. In some embodiments, the control system 356 can be configured to re-transmit the map (with or without follower vehicle processing) to the CFM 350a of a subsequent follower vehicle, for example, via external communication system 354a.

In some embodiments, the route planning module 356b can be configured to plan a route for the follower vehicle, for example, to follow the route driven by the leader vehicle. In some embodiments, the route planning module 356b can employ data from the stored rules of the road 358b and/or data regarding the road network 358c to plan a route that matches that of the leader vehicle in the received map. Drive control module 356d can then control the drive-by-wire system 370 (e.g., an electrical or electro-mechanical system that controls steering, gearing, acceleration, and braking, for example, via control of wheels and respective propulsion units) to have the follower vehicle follow the planned route. In some embodiments, the route planning module 356b can receive information regarding detected features in the environment from sensor suite 352 and can compare that information to the localization features in the received map. Based on that comparison, the route planning module 356b can adjust the route to more closely follow that of the leader vehicle.

In some embodiments, the control system 356 (e.g., via route planning module 356b and/or drive control module 356d) can be configured to apply remedial measures in response to indication of an environmental aspect in the received map. For example, when the received map indicates an area of reduced traction or a slip condition, in some embodiments, the control system 356 can elect to ignore information provided by odometry system 352c when determining position of the follower vehicle due to potential error, or the control system 356 can elect to use the information provided by odometry system 352c but with a different error tolerance or budget. Alternatively or additionally, in some embodiments, when the received map indicates an area of reduced traction or a slip condition, the control system 356 can reduce a speed of the follower vehicle prior to the area and/or avoid acceleration/deceleration in such areas, for example, to avoid losing traction or at least reduce any loss of traction. Alternatively or additionally, in some embodiments, the control system 356 (e.g., via map processing module 356a) can estimate a degree of slip and/or a coefficient of friction, and compute maximum acceleration/deceleration that avoids losing traction or at least reduces any loss of traction. Alternatively or additionally, in some embodiments, when the received map indicates an area of reduced traction or a slip condition, the control system 356 can adopt different path following constraints, for example, such that the follower vehicle can deviate by a greater degree from the leader vehicle route in the area due to likelihood of slippage.

In another example, when the received map indicates an area of dust clouds or an area susceptible to dust production, in some embodiments, the control system 356 can reduce a speed of the follower vehicle prior to and/or within the area to minimize, or at least reduce, dust production. Alternatively or additionally, in some embodiments, when the received map indicates an area of dust clouds or an area susceptible to dust production, the control system 356 can change a separate distance of the follower vehicle from a preceding vehicle in the convoy and/or increase a safety factor. In yet another example, when the received map indicates a washboard (e.g., corrugation) area, in some embodiments, the control system 356 can change a speed of the follower vehicle to avoid, or at least reduce, resonance with the vehicle's suspension. Alternatively or additionally, in some embodiments, when the received map indicates an area with an environmental aspect, the control system 356 can change inflation of one or more tires of the follower vehicle (e.g., via vehicle system 372).

In some embodiments, the obstacle detection module 356c can be configured to detect unexpected obstacles (e.g., other vehicles, pedestrians, etc.) as the follower vehicle moves along the route. The obstacle detection module 356c can be further configured to avoid the detected obstacles, for example, by instructing, via the drive control module 356d, the follower vehicle to follow an alternative path around the obstacle.

In some embodiments, the vehicle state control module 356e can be configured to change an operational state and/or vehicle status of the follower vehicle, for example, to match that of the leader vehicle at a corresponding location along the route. In some embodiments, the vehicle state control module 356e can monitor operational state of the follower vehicle, for example, via data received from vehicle state monitoring system 362 via internal communication system 354b, and/or monitor vehicle status of the follower vehicle, for example, via data received from CAN bus 360 of the follower vehicle via internal communication system 354b. In some embodiments, the vehicle state control module 356e can instruct changes to the operational state and/or vehicle status via vehicle system 372. For example, in some embodiments, when the driver of the leader vehicle has turned on windshield wipers and/or headlights, that vehicle status can be transmitted to the follower vehicle with the map, and the vehicle state control module 356e can instruct the vehicle system 372 of the follower vehicle to also turn on its windshield wipers and/or headlights. In another example, when the driver of the leader vehicle changes a suspension setting at a particular location along the route, in some embodiments, the vehicle state control module 356e can instruct the vehicle system 372 of the follower vehicle to adopt the same suspension setting (or an analogous setting depending on the type of vehicle of the follower vehicle) when the follower vehicle reaches that location along the route.

### III. Computer Implementation

FIG. 3C depicts a generalized example of a suitable computing environment 331 in which the described innovations may be implemented, such as aspects of convoy leader module 104, convoy follow module 114a/114b, convoy leader module 200, convoy leader module 300, convoy follower module 350, method 400, and/or method 410. The computing environment 331 is not intended to suggest any limitation as to scope of use or functionality, as the innovations may be implemented in diverse general-purpose or special-purpose computing systems. For example, the computing environment 331 can be any of a variety of computing devices (e.g., desktop computer, laptop computer, server computer, tablet computer, etc.).

With reference to FIG. 3C, the computing environment 331 includes one or more processing units 335, 337 and memory 339, 341. In FIG. 3C, this basic configuration 351 is included within a dashed line. The processing units 335, 337 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 3C shows a central processing unit 335 as well as a graphics processing unit or co-processing unit 337. The tangible memory 339, 341 may be volatile memory (e.g., registers, cache, RAM), non-volatile memory (e.g., ROM, EEPROM, flash memory, etc.), or some combination of the two, accessible by the processing unit(s). The memory 339, 341 stores software 333 implementing one or more innovations described herein, in the form of computer-executable instructions suitable for execution by the processing unit(s).

A computing system may have additional features. For example, the computing environment 331 includes storage 361, one or more input devices 371, one or more output devices 381, and one or more communication connections 391. An interconnection mechanism (not shown) such as a bus, controller, or network interconnects the components of the computing environment 331. Typically, operating system software (not shown) provides an operating environment for other software executing in the computing environment 331, and coordinates activities of the components of the computing environment 331.

The tangible storage 361 may be removable or non-removable, and includes magnetic disks, magnetic tapes or cassettes, CD-ROMs, DVDs, or any other medium which can be used to store information in a non-transitory way, and which can be accessed within the computing environment 331. The storage 361 can store instructions for the software 333 implementing one or more innovations described herein.

The input device(s) 371 may be a touch input device such as a keyboard, mouse, pen, or trackball, a voice input device, a scanning device, or another device that provides input to the computing environment 331. The output device(s) 371 may be a display, printer, speaker, CD-writer, or another device that provides output from computing environment 331.

The communication connection(s) 391 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### IV. Convoy Methods

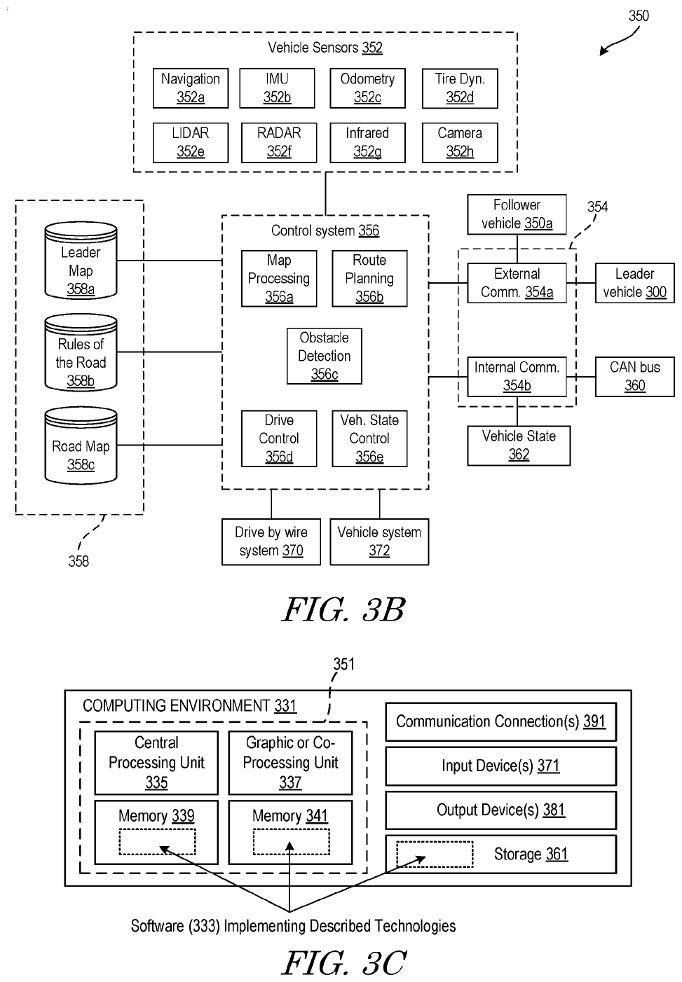

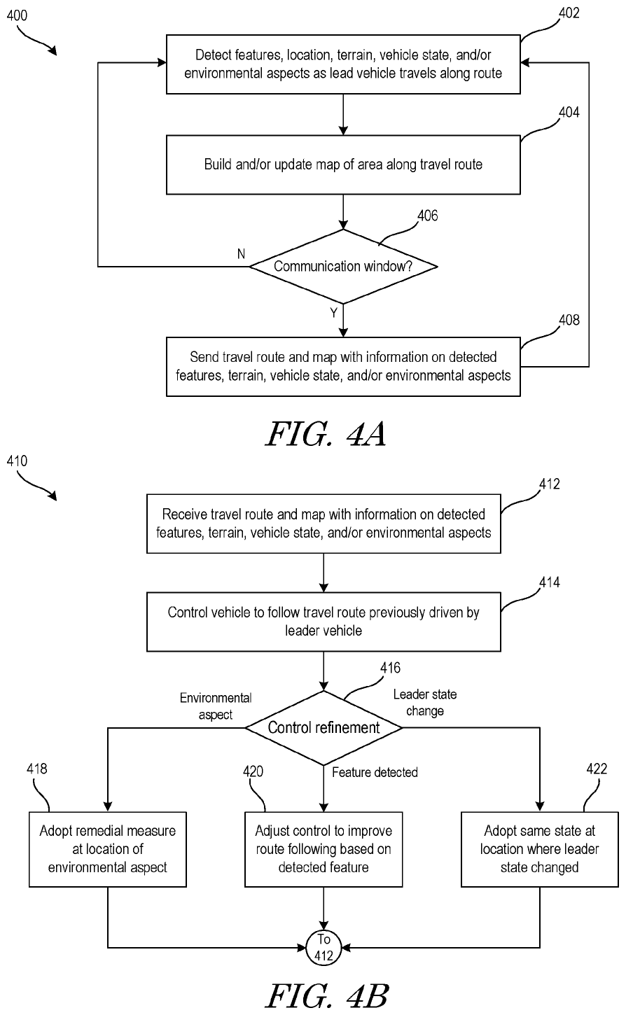

FIG. 4A shows a convoy leader method 400 according to one or more embodiments of the disclosed subject matter. In some embodiments, the convoy leader method 400 can be performed in whole or in part by a module mounted on or integrated with a leader vehicle (e.g., a manned leader vehicle) of a convoy, for example, CLM unit 200 of FIG. 2 and/or CLM 300 of FIG. 3A.

The method 400 can initiate at process block 402, where a route traveled by the leader vehicle (e.g., a history of locations) through an environment is detected. In some embodiments, process block 402 can also include detection of features in the environment that can be used for, or to improve, vehicle localization. Alternatively or additionally, in some embodiments, process block 402 can also include classification of terrain and/or detection of one or more environmental aspects (e.g., a region of reduced traction, a slip condition, a dust cloud, an area susceptible to dust production, road crown, roadway corrugation, roadway washout, pothole, sinkhole, deformable features in roadway, puddle, mud, etc.). In some embodiments, process block 402 can also include detection of an operational state and/or vehicle status of the lead vehicle.

The method 400 can proceed to process block 404, where a map is built for at least part of the environment with the detected route therethrough. In some embodiments, the map can be based at least in part on the detected features in the environment. Alternatively or additionally, process block 404 can involve updating or expanding a previously built map, for example, when the leader vehicle has driven farther along the route and detected additional features. In some embodiments, the map can also include information regarding the classified terrain, detected environmental aspects, operational state, and/or vehicle status. In some embodiments, the map is partly or fully in the form of data as opposed to forming a graphical illustration (e.g., 108a-108d in FIGS. 1A-1D).

The method 400 can proceed to decision block 406, where it is determined if the map and associated information should be transmitted to the follower vehicles in the convoy. For example, in some embodiments, the map and associated information can be transmitted from the leader vehicle at regular intervals (e.g., every second). Alternatively or additionally, in some embodiments, the map and associated information can be transmitted from the leader vehicle on a continuous or substantially continuous basis (e.g., on a periodic basis at ≤500 ms intervals). If transmission is not desired, the method 400 can return to repeat process blocks 402-404, where the map can be updated with additional information/data until the desired transmission window is reached at decision block 406.

If transmission is desired, the method 400 can proceed from decision block 406 to process block 408, where the map with associated information can be communicated to at least one follower vehicle, for example, via radio, Wi-Fi, cellular service, satellite communications, IR signals, EO signals, LIDAR signal, UWB signals, or any combination thereof. In some embodiments, the method 400 can then return to process block 402 for forming a new map and/or updating an existing map based on further progression of the leader vehicle along its route.

FIG. 4B shows a convoy follower method 410 according to one or more embodiments of the disclosed subject matter. In some embodiments, the convoy follower method 410 can be performed in whole or in part by a module mounted on or integrated with a follower vehicle (e.g., an autonomous follower vehicle) of a convoy, for example, CFM 350 of FIG. 3B.

The method 410 can initiate at process block 412, where the transmitted map with associated information is received from the leader vehicle (or an intervening follower vehicle). In some embodiments, process block 412 can include processing the map to extract the route driven by the leader vehicle. Alternatively or additionally, process block 412 can include extracting information regarding localization features, environmental aspects, terrain, operational state of the leader vehicle, and/or leader vehicle status.

The method 410 can proceed to process block 414, where the follower vehicle is controlled to follow the route previously driven by the leader vehicle based at least in part on the extracted route. In some embodiments, process block 414 can include combining the extracted route with predetermined data regarding the rules of the road and/or predetermined data regarding the road network to plan a route that matches that of the leader vehicle in the received map.

The method 410 can proceed to decision block 416, where one or more control refinements can be implemented. For example, in some embodiments, the follower vehicle can separately detect localization features in the environment. The method 410 can thus proceed from decision block 416 to process block 420, where information regarding the localization features detected by the follower vehicle is compared to information regarding the same features in the transmitted map, and the control of the follower vehicle is adjusted to more closely follow that of the leader vehicle based on the comparison of the detected features. Alternatively or additionally, in some embodiments, if the transmitted map indicates an environmental aspect that could impact operation of the follower vehicle, the method 410 can proceed from decision block 416 to process block 418, where the follower vehicle can adopt or implement one or more remedial measures prior to or at a location of the environmental aspect. For example, when the environmental aspect is a slippery area, the follower vehicle can slow down as it approaches the slippery area indicated in the map, can avoid changing speed within the slippery area, can increase following distance prior to or within the slippery area, can ignore or compensate for expected sensor errors in the slippery area, etc. In another example, when

Alternatively or additionally, in some embodiments, if the transmitted map indicates a change in operational state and/or vehicle status of the leader vehicle, the method 410 can proceed from decision block 416 to process block 422, where the follower vehicle can adopt or implement the same change (or an analogous change, if the follower vehicle is a different type from the leader vehicle) immediately or at a location where the leader vehicle made the change. For example, when the windshield wipers and/or headlights are activated in the leader vehicle, the follower vehicle can also activate its windshield wipers and/or headlights. In another example, when a suspension setting has been changed in the leader vehicle at a particular location, the follower vehicle can also change its suspension setting in a corresponding manner when it reaches that location. In some embodiments, the method 410 can then return to process block 412 for processing of the next transmitted map and/or controlling the follower vehicle to follow the route driven by the leader vehicle.

Although some of blocks 402-408 of method 400 and blocks 412-422 of method 410 have been described as being performed once, in some embodiments, multiple repetitions of a particular process block may be employed before proceeding to the next decision block or process block. In addition, although blocks 402-408 of method 400 and blocks 412-422 of method 410 have been separately illustrated and described, in some embodiments, process blocks may be combined and performed together (simultaneously or sequentially). Moreover, although FIG. 4A illustrates a particular order for blocks 402-408 and FIG. 4B illustrates a particular order for blocks 412-422, embodiments of the disclosed subject matter are not limited thereto. Indeed, in certain embodiments, the blocks may occur in a different order than illustrated or simultaneously with other blocks. For example, even though detection of process block 402 is shown occurring prior to map building/updating of process block 404, in some embodiments, process blocks 402, 404 can occur simultaneously or overlapping, e.g., when features are continuously detected and incorporated into the map building/updating on an ongoing basis.

### V. Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.
Clause 1. A convoy system comprising:
a convoy leader module for a leader vehicle of a convoy, the convoy leader module comprising:
   a first suite of sensors, the first suite comprising at least one feature sensor operable to detect features or terrain in an environment to be traversed by the leader vehicle and at least one location sensor operable to determine a location of the leader vehicle;
   a first communication system operable to transmit one or more signals between the leader vehicle and one or more follower vehicles in the convoy; and
   a first controller operatively coupled to the first suite of sensors and the first communication system, the first controller comprising one or more first processors and first non-transitory computer readable storage media storing instructions that, when executed by the one or more first processors, cause the first controller to:
      detect, via the at least one feature sensor, one or more features as the leader vehicle travels along a route through the environment;
      detect, via the at least one location sensor, the route of the leader vehicle through the environment;
      build, based at least in part on the detected one or more features and the detected route, a map for at least part of the environment with the detected route therethrough; and
      transmit, via the first communication system, first data indicative of the map and the detected route to the one or more follower vehicles in the convoy.
Clause 2. The convoy system of any clause or example herein, in particular clause 1, wherein the convoy leader module is constructed as a modular unit that can be coupled to the leader vehicle.
Clause 3. The convoy system of any clause or example herein, in particular, any one of clauses 1-2, wherein the convoy leader module is constructed to be coupled to a bumper, a roof, a hood, or a cabin wall of a truck, to a roof or sidewall of a trailer, or in a gap between the truck and the trailer.
Clause 4. The convoy system of any clause or example herein, in particular, any one of clauses 1-3, wherein the at least one feature sensor in the first suite of sensors comprises an electro-optical (EO) camera, an infra-red (IR) sensor, a thermal sensor, a light detection and ranging (LIDAR) system, a radio detection and ranging (RADAR) system, or any combination of the foregoing.
Clause 5. The convoy system of any clause or example herein, in particular, any one of clauses 1-4, wherein the at least one location sensor in the first suite of sensors comprises a global navigation satellite system (GNSS) sensor, an inertial measurement unit (IMU), a differential GNSS station, a dynamic base real-time kinematic (DRTK) device, an ultra-wideband (UWB) radio, a visual odometry device, a light detection and ranging (LIDAR) odometry system, a radio detection and ranging (RADAR) odometry system, or any combination of the foregoing.
Clause 6. The convoy system of any clause or example herein, in particular, any one of clauses 1-5, wherein the first communication system is configured is a vehicle-to-everything (V2X) communication system.
Clause 7. The convoy system of any clause or example herein, in particular, any one of clauses 1-6, wherein the transmitted first data is descriptive of at least one lane marking, at least one lane width, at least one road sign, at least one road grade, at least one road condition, at least one road hazard, or any combination of the foregoing.
Clause 8. The convoy system of any clause or example herein, in particular, any one of clauses 1-7, further comprising a convoy follower module for an autonomous follower vehicle in the convoy, the convoy follower module comprising:
a second suite of sensors comprising at least one feature sensor operable to detect features in the environment to be traversed by the autonomous follower vehicle;
a second communication system operable to transmit one or more signals (i) between the autonomous follower vehicle and the leader vehicle, (ii) between the autonomous follower vehicle and other vehicles in the convoy, or (iii) both (i) and (ii); and
a second controller operatively coupled to the second suite of sensors and the second communication system, the second controller comprising one or more second processors and second non-transitory computer readable storage media storing instructions that, when executed by the one or more second processors, cause the second controller to:
   receive, via the second communication system, the first data indicative of the map and the route;
   detect, via the at least one feature sensor in the second suite of sensors, one or more features in the environment surrounding the autonomous follower vehicle; and
   control, via a drive-by-wire kit, the autonomous follower vehicle to follow the route based at least in part on the first data and the detected one or more features.
Clause 9. The convoy system of any clause or example herein, in particular clause 8, wherein:
the second suite of sensors further comprises at least one location sensor operable to determine a location of the autonomous follower vehicle,
the second non-transitory computer readable storage media stores additional instructions, that, when executed by the one or more second processors cause the second controller to detect, via the at least one location sensor, a location of the autonomous follower vehicle, and
the control of the autonomous follower vehicle to follow the route is based at least in part on the first data, the detected one or more features, and the detected location.
Clause 10. The convoy system of any clause or example herein, in particular, any one of clauses 1-7, wherein the first suite of sensors comprises at least one wheel odometry sensor, or the leader vehicle comprises at least one wheel odometry sensor.
Clause 11. The convoy system of any clause or example herein, in particular clause 10, wherein:
the first non-transitory computer readable storage media stores additional instructions that, when executed by the one or more first processors, further cause the first controller to detect a slip condition of the leader vehicle based on a comparison of data from the at least one wheel odometry sensor and data from the at least one location sensor, and
the transmitted first data is further indicative of the slip condition and a location of the slip condition.
Clause 12. The convoy system of any clause or example herein, in particular, any one of clauses 10-11, further comprising a convoy follower module for an autonomous follower vehicle in the convoy, the convoy follower module comprising:
a second suite of sensors;
a second communication system operable to transmit one or more signals (i) between the autonomous follower vehicle and the leader vehicle, (ii) between the autonomous follower vehicle and other vehicles in the convoy, or (iii) both (i) and (ii); and
a second controller operatively coupled to the second suite of sensors and the second communication system, the second controller comprising one or more second processors and second non-transitory computer readable storage media storing instructions that, when executed by the one or more second processors, cause the second controller to:
   receive, via the second communication system, the first data indicative of the map, the route, the slip condition, and the location of the slip condition;
   control, via a drive-by-wire kit, the autonomous follower vehicle to follow the route based at least in part on the first data;
   detect, via the second suite of sensors, a location of the autonomous follower vehicle approaching or matching the location of the slip condition; and
   implement one or more remedial measures as the autonomous follower vehicle traverses the location of the slip condition.
Clause 13. The convoy system of any clause or example herein, in particular clause 12, wherein the one or more remedial measures comprise:
determining location of the autonomous follower vehicle without use of wheel odometry data;
changing an error budget for use of wheel odometry data in determining location of the autonomous follower vehicle;
determining location of the autonomous follower vehicle by correlating a direction of detected error in wheel odometry with that from the leader vehicle;
avoiding acceleration, deceleration, or both while in the location of the slip condition;
changing a speed of the autonomous follower vehicle to reduce traction loss in the location of the slip condition;
changing a distance between vehicles in the convoy;
allowing greater deviations of the autonomous follower vehicle from the route in the location of the slip condition;
changing an inflation state of one or more tires of the autonomous follower vehicle; or
any combination of the above.
Clause 14. The convoy system of any clause or example herein, in particular, any one of clauses 1-7, wherein the leader vehicle comprises a plurality of wheel encoders, each wheel encoder being associated with a respective wheel of the leader vehicle.
Clause 15. The convoy system of any clause or example herein, in particular clause 14, wherein:
the first non-transitory computer readable storage media stores additional instructions that, when executed by the one or more first processors, further cause the first controller to detect a slip condition of the leader vehicle based on a comparison of data from the plurality of wheel encoders, and
the transmitted first data is further indicative of the slip condition and a location of the slip condition.
Clause 16. The convoy system of any clause or example herein, in particular, any one of clauses 14-15, further comprising a convoy follower module for an autonomous follower vehicle in the convoy, the convoy follower module comprising:
a second suite of sensors;
a second communication system operable to transmit one or more signals (i) between the autonomous follower vehicle and the leader vehicle, (ii) between the autonomous follower vehicle and other vehicles in the convoy, or (iii) both (i) and (ii); and
a second controller operatively coupled to the second suite of sensors and the second communication system, the second controller comprising one or more second processors and second non-transitory computer readable storage media storing instructions that, when executed by the one or more second processors, cause the second controller to:
   receive, via the second communication system, the first data indicative of the map, the route, the slip condition, and the location of the slip condition;
   control, via a drive-by-wire kit, the autonomous follower vehicle to follow the route based at least in part on the first data;
   detect, via the second suite of sensors, a location of the autonomous follower vehicle approaching or matching the location of the slip condition; and
   implement one or more remedial measures as the autonomous follower vehicle traverses the location of the slip condition.
Clause 17. The convoy system of any clause or example herein, in particular clause 16, wherein the one or more remedial measures comprise:
determining location of the autonomous follower vehicle without use of wheel odometry data;
changing an error budget for use of wheel odometry data in determining location of the autonomous follower vehicle;
determining location of the autonomous follower vehicle by correlating a direction of detected error in wheel odometry with that from the leader vehicle;
avoiding acceleration, deceleration, or both while in the location of the slip condition;
changing a speed of the autonomous follower vehicle to reduce traction loss in the location of the slip condition;
changing a distance between vehicles in the convoy;
allowing greater deviations of the autonomous follower vehicle from the route in the location of the slip condition;
changing an inflation state of one or more tires of the autonomous follower vehicle; or any combination of the above.
Clause 18. The convoy system of any clause or example herein, in particular, any one of clauses 1-17, wherein:
the first non-transitory computer readable storage media stores additional instructions that, when executed by the one or more first processors, further cause the first controller to classify a terrain of the route through the environment, and
the transmitted first data is further indicative of the classified terrain.
Clause 19. The convoy system of any clause or example herein, in particular clause 18, wherein:
the first suite of sensors comprises a strain gauge, an accelerometer, or both a strain gauge and accelerometer, and
the first controller classifies the terrain based at least in part on data from the strain gauge, the accelerometer, or both the strain gauge and the accelerometer.
Clause 20. The convoy system of any clause or example herein, in particular, any one of clauses 1-7, wherein:
the first non-transitory computer readable storage media stores additional instructions that, when executed by the one or more first processors, further cause the first controller to detect, via the first suite of sensors, an environmental aspect in or along the route and a location of the environmental aspect, and
the transmitted first data is further indicative of the environmental aspect and the location of the environmental aspect.
Clause 21. The convoy system of any clause or example herein, in particular clause 20, wherein the environmental aspect comprises a dust cloud, an area susceptible to dust production, road crown, roadway corrugation, roadway washout, pothole, sinkhole, deformable features in roadway, puddle, mud, or any combination of the foregoing.
Clause 22. The convoy system of any clause or example herein, in particular, any one of clauses 20-21, further comprising a convoy follower module for an autonomous follower vehicle in the convoy, the convoy follower module comprising:
a second suite of sensors;
a second communication system operable to transmit one or more signals (i) between the autonomous follower vehicle and the leader vehicle, (ii) between the autonomous follower vehicle and other vehicles in the convoy, or (iii) both (i) and (ii); and
a second controller operatively coupled to the second suite of sensors and the second communication system, the second controller comprising one or more second processors and second non-transitory computer readable storage media storing instructions that, when executed by the one or more second processors, cause the second controller to:
   receive, via the second communication system, the first data indicative of the map, the route, the environmental aspect, and the location of the environmental aspect;
   control, via a drive-by-wire kit, the autonomous follower vehicle to follow the route based at least in part on the first data;
   detect, via the second suite of sensors, a location of the autonomous follower vehicle approaching or matching the location of the environmental aspect; and
   implement one or more remedial measures as the autonomous follower vehicle traverses the location of the environmental aspect.
Clause 23. The convoy system of any clause or example herein, in particular clause 22, wherein the one or more remedial measures comprise:
changing an acceleration/deceleration profile available for autonomous follower vehicle;
changing a speed of the autonomous follower vehicle;
changing a distance between vehicles in the convoy; or
any combination of the above.
Clause 24. The convoy system of any clause or example herein, in particular, any one of clauses 1-23, wherein the convoy leader module further comprises a user interface disposed within a driver cabin of the leader vehicle.
Clause 25. The convoy system of any clause or example herein, in particular clause 24, wherein the user interface is configured to accept user input defining operation of the convoy, and the first data is indicative of the user input.
Clause 26. The convoy system of any clause or example herein, in particular, any one of clauses 1-25, wherein the convoy leader module is configured to monitor an operational state of the leader vehicle, and the first data is indicative of the monitored operational state.
Clause 27. The convoy system of any clause or example herein, in particular clause 26, wherein the operational state comprises a state of a vehicle suspension, a state of a braking system, a state of a traction modality, a state of vehicle lighting, a state of windshield wipers, or any combination of the foregoing.
Clause 28. The convoy system of any clause or example herein, in particular, any one of clauses 1-27, wherein the leader vehicle is manually driven along the route.
Clause 29. The convoy system of any clause or example herein, in particular, any one of clauses 1-27, wherein the leader vehicle is an autonomous vehicle.
Clause 30. The convoy system of any clause or example herein, in particular, any one of clauses 1-29, wherein the leader vehicle comprises a truck, a bus, a shuttle, a car, an aircraft, a construction vehicle, a mining vehicle, an agricultural vehicle, a warehouse vehicle, or any combination of the foregoing.
Clause 31. A convoy system comprising:
(a) a leader vehicle comprising:
   a first suite of sensors, the first suite comprising at least one feature sensor operable to detect features or terrain in an environment to be traversed by the leader vehicle and at least one location sensor operable to determine a location of the leader vehicle;
   a first communication system operable to transmit one or more signals between the leader vehicle and one or more follower vehicles in the convoy; and
   a first controller operatively coupled to the first suite of sensors and the first communication system, the first controller comprising one or more first processors and first non-transitory computer readable storage media storing instructions that, when executed by the one or more first processors, cause the first controller to:
      detect, via the at least one feature sensor, one or more features as the leader vehicle travels along a route through the environment;
      detect, via the at least one location sensor, the route of the leader vehicle through the environment;
      build, based at least in part on the detected one or more features and the detected route, a map for at least part of the environment with the detected route therethrough; and
      transmit, via the first communication system, first data indicative of the map and the detected route to the one or more follower vehicles in the convoy; and
(b) a plurality of autonomous follower vehicles for following the leader vehicle in the convoy, each autonomous follower vehicle comprising:
   a drive-by-wire kit;
   a second suite of sensors;
   a second communication system operable to transmit one or more signals between the plurality of autonomous follower vehicles, the leader vehicle, or both; and
   a second controller operatively coupled to the second suite of sensors and the second communication system, the second controller comprising one or more second processors and second non-transitory computer readable storage media storing instructions that, when executed by the one or more second processors, cause the second controller to:
      receive, via the second communication system, the first data; and
      control, via the drive-by-wire kit, the respective autonomous follower vehicle to follow the route based at least in part on the first data.
Clause 32. The convoy system of any clause or example herein, in particular clause 31, wherein:
(i) the first suite of sensors, the second suite of sensors, or both comprise an electro-optical (EO) camera, an infra-red (IR) sensor, a thermal sensor, a light detection and ranging (LIDAR) system, a radio detection and ranging (RADAR) system, or any combination of the foregoing;
(ii) the first suite of sensors, the second suite of sensors, or both comprise a global navigation satellite system (GNSS) sensor, an inertial measurement unit (IMU), a differential GNSS station, a dynamic base real-time kinematic (DRTK) device, an ultra-wideband (UWB) radio, a visual odometry device, a light detection and ranging (LIDAR) odometry system, a radio detection and ranging (RADAR) odometry system, or any combination of the foregoing;
(iii) the first suite of sensors, the second suite of sensors, or both comprise at least one wheel odometry sensor, a plurality of wheel encoders, a strain gauge, an accelerometer, or any combination of the foregoing; or
(iv) any combination of (i)-(iii).
Clause 33. The convoy system of any clause or example herein, in particular, any one of clauses 31-32, wherein:
the second non-transitory computer readable storage media stores additional instructions that, when executed by the one or more second processors cause the second controller to detect, via the second suite of sensors, one or more features in the environment surrounding the autonomous follower vehicle, and
the respective autonomous follower vehicle is controlled to follow the route based at least in part on the first data and the detected one or more features.
Clause 34. The convoy system of any clause or example herein, in particular, any one of clauses 31-33, wherein:
the first non-transitory computer readable storage media stores additional instructions that, when executed by the one or more first processors, further cause the first controller to detect a slip condition of the leader vehicle based on (a) a comparison of data from at least one wheel odometry sensor and data from the at least one location sensor, (b) a comparison of data from a plurality of wheel encoders, or (c) both (a) and (b);
the transmitted first data is further indicative of the slip condition and a location of the slip condition; and
the second non-transitory computer readable storage media stores additional instructions that, when executed by the one or more second processors cause the second controller to:
   detect, via the second suite of sensors, a location of the autonomous follower vehicle approaching or matching the location of the slip condition; and
   implement one or more remedial measures as the autonomous follower vehicle traverses the location of the slip condition.
Clause 35. The convoy system of any clause or example herein, in particular clause 34, wherein the one or more remedial measures comprise:
determining location of the autonomous follower vehicle without use of wheel odometry data;
changing an error budget for use of wheel odometry data in determining location of the autonomous follower vehicle;
determining location of the autonomous follower vehicle by correlating a direction of detected error in wheel odometry with that from the leader vehicle;
avoiding acceleration, deceleration, or both while in the location of the slip condition;
changing a speed of the autonomous follower vehicle to reduce traction loss in the location of the slip condition;
changing a distance between vehicles in the convoy;
allowing greater deviations of the autonomous follower vehicle from the route in the location of the slip condition;
changing an inflation state of one or more tires of the autonomous follower vehicle; or
any combination of the above.
Clause 36. The convoy system of any clause or example herein, in particular, any one of clauses 31-35, wherein:
the first non-transitory computer readable storage media stores additional instructions that, when executed by the one or more first processors, further cause the first controller to classify a terrain of the route through the environment, and
the transmitted first data is further indicative of the classified terrain.
Clause 37. The convoy system of any clause or example herein, in particular, any one of clauses 31-36, wherein:
the first non-transitory computer readable storage media stores additional instructions that, when executed by the one or more first processors, further cause the first controller to detect, via the first suite of sensors, an environmental aspect in or along the route and a location of the environmental aspect;
the transmitted first data is further indicative of the environmental aspect and the location of the environmental aspect; and
the second non-transitory computer readable storage media stores additional instructions that, when executed by the one or more second processors cause the second controller to:
   detect, via the second suite of sensors, a location of the autonomous follower vehicle approaching or matching the location of the environmental aspect; and
   implement one or more remedial measures as the autonomous follower vehicle traverses the location of the environmental aspect.
Clause 38. The convoy system of any clause or example herein, in particular, clause 37, wherein:
(i) the environmental aspect comprises a dust cloud, an area susceptible to dust production, road crown, roadway corrugation, roadway washout, pothole, sinkhole, deformable features in roadway, puddle, mud, or any combination of the foregoing;
(ii) the one or more remedial measures comprise:
   changing an acceleration/deceleration profile available for autonomous follower vehicle;
   changing a speed of the autonomous follower vehicle;
   changing a distance between vehicles in the convoy; or
   any combination of the above; or
(iii) both (i) and (ii).
Clause 39. The convoy system of any clause or example herein, in particular, any one of clauses 31-38, wherein the leader vehicle comprises an interface configured to accept user input defining operation of the convoy, and the first data is indicative of the user input.
Clause 40. The convoy system of any clause or example herein, in particular, any one of clauses 31-39, wherein:
the first non-transitory computer readable storage media stores additional instructions that, when executed by the one or more first processors, further cause the first controller to receive data regarding an operational state of the leader vehicle; and
the first data is indicative of the operational state of the leader vehicle.
Clause 41. The convoy system of any clause or example herein, in particular, clause 40, wherein the operational state comprises a state of a vehicle suspension, a state of a braking system, a state of a traction modality, a state of vehicle lighting, a state of windshield wipers, or any combination of the foregoing.
Clause 42. The convoy system of any clause or example herein, in particular, any one of clauses 1-41, wherein the leader vehicle is constructed to be manually driven along the route.
Clause 43. The convoy system of any clause or example herein, in particular, any one of clauses 1-41, wherein:
the leader vehicle further comprises a drive-by-wire kit; and
the first non-transitory computer readable storage media stores additional instructions that, when executed by the one or more first processors, further cause the first controller to control, via the drive-by-wire kit, the respective leader vehicle to follow the route.
Clause 44. The convoy system of any clause or example herein, in particular, any one of clauses 1-43, wherein the leader vehicle, the plurality of autonomous follower vehicles, or both comprise a truck, a bus, a shuttle, a car, an aircraft, a construction vehicle, a mining vehicle, an agricultural vehicle, a warehouse vehicle, or any combination of the foregoing.
Clause 45. The convoy system of any clause or example herein, in particular, any one of clauses 1-44, wherein a size, vehicle type, vehicle make, or vehicle model of the leader vehicle is different from that of at least one of the plurality of autonomous follower vehicles.
Clause 46. The convoy system of any clause or example herein, in particular, any one of clauses 1-45, wherein the first communication system, at least one of the second communication systems, or each of the first and second communication systems are configured is a vehicle-to-everything (V2X) communication system.
Clause 47. A convoy system comprising:
a manned leader vehicle;
a manned leader electronics kit coupled to the manned leader vehicle, the manned leader electronics kit comprising:
   an electronic processing device;
   at least one environment sensor in communication with the electronic processing device;
   at least one location sensor in communication with the electronic processing device;
   a wireless communication device in communication with the electronic processing device; and
   a non-transitory computer-readable medium storing instructions that when executed by the electronic processing device, result in:
      receiving first data from the at least one environment sensor;
      receiving second data from the at least one location sensor; and
      transmitting the first and second data to at least one autonomous vehicle.
Clause 48. The convoy system of any clause or example herein, in particular, clause 47, wherein the at least one environment sensor comprises one or more of an electro-optic (EO) camera, an infra-red (IR) sensor, a thermal sensor, a light detection and ranging (LIDAR) sensor, a radio detection and ranging (RADAR) sensor, and a vehicle-to-everything (V2X) sensor.
Clause 49. The convoy system of any clause or example herein, in particular, any one of clauses 47-48, wherein the at least one location sensor comprises one or more of a global navigation satellite system (GNSS) sensor, an inertial sensor, a differential GNSS station, a dynamic base real-time kinematic (RTK) positioning device, an ultra-wideband (UWB) radio, a visual odometry device, a LIDAR odometry device, and a RADAR odometry device.
Clause 50. The convoy system any clause or example herein, in particular, any one of clauses 47-49, wherein the instructions, when executed by the electronic processing device, further result in:
measuring third data descriptive of one or more of a state of the manned leader vehicle, a speed of the manned leader vehicle, an engine/motor speed of the manned leader vehicle, a steering column position of the manned leader vehicle, a brake status of the manned leader vehicle, an acceleration status of the manned leader vehicle, a gear status of the manned leader vehicle, a wipers of the manned leader vehicle, a blinker status of the manned leader vehicle, a fuel consumption value of the manned leader vehicle, a battery state of charge of the manned leader vehicle, a vehicle identifier of the manned leader vehicle, a cargo data value of the manned leader vehicle, and a light setting status of the of the manned leader vehicle; and
transmitting the third data to the at least one autonomous vehicle.
Clause 51. The convoy system of any clause or example herein, in particular, any one of clauses 47-50, wherein the instructions, when executed by the electronic processing device, further result in:
computing, based on one or more of the first data and the second data, third data comprising a location of an object in an environment proximate to the manned leader vehicle; and
transmitting the third data to the at least one autonomous vehicle.
Clause 52. The convoy system of any clause or example herein, in particular, clause 51, wherein the object comprises a plurality of objects and wherein the third data comprises a map.
Clause 53. The convoy system of any clause or example herein, in particular, clause 52, wherein the map is descriptive of at least one of a lane marking, a lane width, a road sign, a road grade, a road condition, and a hazard.
Clause 54. The convoy system of any clause or example herein, in particular, any one of clauses 47-53, wherein the instructions, when executed by the electronic processing device, further result in:
measuring third data descriptive of one or more of an eye movement of a driver of the manned leader vehicle, a status of a seat occupancy sensor of the driver of the manned leader vehicle, a status of a steering wheel contact sensor of the driver of the manned leader vehicle, and a status of a pedal contact sensor of the driver of the manned leader vehicle; and
transmitting the third data to the at least one autonomous vehicle.
Clause 55. The convoy system of any clause or example herein, in particular, any one of clauses 47-54, wherein the manned leader electronics kit further comprises an input interface with at least one graphical input element and wherein the instructions, when executed by the electronic processing device, further result in:
receiving, via the at least one graphical input element and from a driver of the manned leader vehicle, third data comprising a definition of a parameter for the at least one autonomous vehicle; and
transmitting the third data to the at least one autonomous vehicle.
Clause 56. The convoy system of any clause or example herein, in particular, clause 55, wherein the third data comprises a definition of at least one of a following distance and a following order.
Clause 57. The convoy system of any clause or example herein, in particular, any one of clauses 55-56, wherein the third data comprises a definition of a command to execute a driving maneuver.
Clause 58. The convoy system of any clause or example herein, in particular, clause 57, wherein the driving maneuver comprises one or more of a parking maneuver, a docking maneuver, a stopping maneuver, and a routing maneuver.
Clause 59. The convoy system of any clause or example herein, in particular, any one of clauses 47-58, wherein the manned leader electronics kit further comprises an output device and wherein the instructions, when executed by the electronic processing device, further result in:
receiving, from the at least one autonomous vehicle, third data descriptive of a status of the at least one autonomous vehicle; and
outputting, by the output device and to a driver of the manned leader vehicle, the third data.
Clause 60. The convoy system of any clause or example herein, in particular, any one of clauses 47-59, wherein the manned leader electronics kit further comprises a power source in communication with the electronic processing device.
Clause 61. The convoy system of any clause or example herein, in particular, clause 60, wherein the power source comprises one or more of a battery, a solar power source, and a wind power source.
Clause 62. The convoy system of any clause or example herein, in particular, any one of clauses 47-61, wherein the manned leader electronics kit is coupled to one or more of a roof, a bumper, a hood, a front license plate, a mirror, a cab, and a trailer of the manned leader vehicle.
Clause 63. The convoy system of any clause or example herein, in particular, any one of clauses 47-62, wherein the manned leader vehicle comprises one or more of a truck, a bus, a shuttle, a car, an aircraft, and a construction, mining, agricultural, or warehouse vehicle.
Clause 64. The convoy system of any clause or example herein, in particular, any one of clauses 47-63, wherein a distance between the manned leader vehicle and the at least one autonomous vehicle is greater than one mile and wherein the wireless communication device comprises one or more of a cellular communications device and a satellite communications device.
Clause 65. The convoy system of any clause or example herein, in particular, any one of clauses 47-64, wherein the first data is descriptive of one or more of a road condition, a friction coefficient, a rolling resistance value, a terrain deformation value, and a topology value.
Clause 66. The convoy system of any clause or example herein, in particular, any one of clauses 47-65, wherein the second data is descriptive of one or more of an elevation, a speed, an acceleration, and a pitch of the manned leader vehicle.
Clause 67. A convoy system comprising:
an appliance attachable to a manned leader vehicle of a convoy of autonomous vehicles, the appliance comprising:
   one or more first sensors configured to sense terrain in an environment around the leader vehicle;
   one or more second sensors configured to sense location of the leader vehicle, velocity of the leader vehicle, heading of the leader vehicle, past trajectory of the leader vehicle, or any combination of the foregoing;
   a communication system configured to communicate with one or more follower vehicles in the convoy; and
   a controller operatively coupled to the communication system and the first and second sensors, the controller being configured to process data from the first and second sensors and to relay information based on the processed data to the one or more follower vehicles via the communication system.
Clause 68. The convoy system of any clause or example herein, in particular, clause 67, wherein the one or more first sensors comprise at least one electro-optic (EO) camera, at least one infrared camera, at least one thermal camera, at least one light detection and ranging (LIDAR) system, at least one radio detection and ranging (RADAR) system, at least one vehicle-to-everything (V2X) system or sensor, or any combination of the foregoing.
Clause 69. The convoy system of any clause or example herein, in particular, any one of clauses 67-68, wherein the one or more second sensors comprise at least one global navigation satellite systems (GNSS), at least one inertial sensor, at least one differential GNSS station, at least one dynamic base real-time kinematics (RTK) device, at least one ultra-wideband radio, at least one visual odometry device, at least one LIDAR odometry device, at least one radar odometry device, or any combination of the foregoing.
Clause 70. The convoy system of any clause or example herein, in particular, any one of clauses 67-69, wherein the appliance is further configured to measure a state of the leader vehicle based on speed from wheel odometry, engine or motor speed, steering column position, brake status, acceleration status, gear status, wipers, blinkers, lights, or any combination of the foregoing.
Clause 71. The convoy system of any clause or example herein, in particular, any one of clauses 67-70, wherein one or more first sensors, the one or more second sensors, or both the first and second sensors are configured to measure localization landmarks and their position with respect to a trajectory of the leader, and the controller is further configured to relay data regarding the localization landmarks and their positions to the follower vehicles via the communication system.
Clause 72. The convoy system of any clause or example herein, in particular, any one of clauses 67-71, where the appliance, the one or more first sensors, the one or more second sensors, or any combination of the foregoing is configured to measure movement, attention, or both of a driver of the leader vehicle.
Clause 73. The convoy system of any clause or example herein, in particular, clause 72, wherein the appliance, the one or more first sensors, or the one or more second sensors comprises an eye tracking system, a seat occupancy sensor, a steering wheel contact sensor, a pedal contact sensor, or any combination of the foregoing.
Clause 74. The convoy system of any clause or example herein, in particular, any one of clauses 67-73, wherein the controller is further configured to create one or more maps of static objects, moving objects, lane markings, lane width, signs, road grade, road conditions, fuel economy, speeds, hazards, or any combination of the foregoing, and to transmit the one or more maps to the immediately following vehicle or all of the following autonomous vehicles in the convoy.
Clause 75. The convoy system of any clause or example herein, in particular, any one of clauses 67-74, wherein the appliance further comprises an interface configured to receive input from a human in the lead vehicle regarding driving modalities, following distances, or both, and the controller is further configured to transmit the input to the one or more follower vehicles.
Clause 76. The convoy system of any clause or example herein, in particular, any one of clauses 67-74, wherein the appliance further comprises an interface configured to provide to a human in the lead vehicle visual or audio output regarding a status, a health, or both of the one or more follower vehicles.
Clause 77. The convoy system of any clause or example herein, in particular, any one of clauses 67-74, wherein the appliance further comprises an interface configured to receive commands from a human in the lead vehicle, and the controller is further configured to transmit the commands to the one or more follower vehicles to cause the respective follower vehicle to perform an autonomous maneuver.
Clause 78. The convoy system of any clause or example herein, in particular, clause 77, wherein the autonomous maneuver comprises a parking maneuver, a docking maneuver, a stopping maneuver, driving along a route, driving to a specified location, or any combination of the foregoing.
Clause 79. The convoy system of any clause or example herein, in particular, any one of clauses 67-78, wherein the appliance further comprises a battery, or the appliance is electrically connected to a battery of the lead vehicle.
Clause 80. The convoy system of any clause or example herein, in particular, any one of clauses 67-79, wherein the appliance is solar powered or powered by the wind.
Clause 81. The convoy system of any clause or example herein, in particular, any one of clauses 67-80, wherein at least one of the one or more first sensors, at least one of the one or more second sensors, or both the first and second sensors are mounted on a roof of the lead vehicle, a bumper of the lead vehicle, a hood of the lead vehicle, a front plate of the lead vehicle, a mirror of the lead vehicle, inside a cabin of the lead vehicle, or on a trailer attached to the lead vehicle.
Clause 82. The convoy system of any clause or example herein, in particular, any one of clauses 67-80, wherein the appliance is mounted on a roof of the lead vehicle, a bumper of the lead vehicle, a hood of the lead vehicle, a front plate of the lead vehicle, a mirror of the lead vehicle, inside a cabin of the lead vehicle, or on a trailer attached to the lead vehicle.
Clause 83. The convoy system of any clause or example herein, in particular, any one of clauses 67-82, wherein the appliance is mounted on a truck, a bus, a shuttle, a car, an aircraft, a construction vehicle, a mining vehicle, an agricultural, or a warehouse vehicle.
Clause 84. The convoy system of any clause or example herein, in particular, any one of clauses 67-83, where a vehicle make, a vehicle model, or both of the leader vehicle is different than that of at least one of the follower vehicles.
Clause 85. The convoy system of any clause or example herein, in particular, any one of clauses 67-84, wherein the leader vehicle is configured to drive the route with each of the follower vehicles being out of view.
Clause 86. The convoy system of any clause or example herein, in particular, clause 85, wherein the communication system is configured to communicate with the one or more follower vehicles via Wi-Fi, cellular service, satellite communications, or any combination of the foregoing.
Clause 87. The convoy system of any clause or example herein, in particular, any one of clauses 67-86, wherein the one or more follower vehicles are configured to follow the leader vehicle based at least in part on a combination of a-priori data with data transmitted from the leader vehicle.
Clause 88. The convoy system of any clause or example herein, in particular, any one of clauses 67-87, wherein the appliance further comprises a data storage device that stores information regarding available routes, and the controller is further configured to use the stored information to complement data sensed by the first and/or second sensors (e.g., speed limit, road names, road signs, rules of the road, etc.).
Clause 89. The convoy system of any clause or example herein, in particular, any one of clauses 67-88, further comprising a second appliance mountable on a second vehicle, wherein the appliance is configured to transfer control of convoy to the second appliance of the second vehicle.
Clause 90. The convoy system of any clause or example herein, in particular, any one of clauses 67-89, wherein the communication system is configured to communicate using infrared signals, electro-optical signals, a light detection and ranging (LIDAR) system, an ultra-wideband (UWB) device, or any combination of the foregoing.
Clause 91. The convoy system of any clause or example herein, in particular, any one of clauses 67-90, wherein the appliance comprises one or more fiducials, and the one or more followers are configured to detect the one or more fiducials.
Clause 92. The convoy system of any clause or example herein, in particular, any one of clauses 67-91, wherein the appliance further comprises an interface configured to receive from a human in the lead vehicle selection of an order of follower vehicles in the convoy, and the controller is further configured to transmit the selection to the one or more follower vehicles to cause the respective follower vehicles to arrange within the convoy according to the selection.
Clause 93. The convoy system of any clause or example herein, in particular, any one of clauses 67-93, wherein the appliance further comprises an interface configured to receive from a human in the lead vehicle specification of one or more separation distances for follower vehicles in the convoy, and the controller is further configured to transmit the specification to the one or more follower vehicles to cause the respective follower vehicles to maintain the respective separation distance according to the specification.
Clause 94. The convoy system of any clause or example herein, in particular, any one of clauses 67-93, wherein the one or more follower vehicles are configured to automatically link or unlink with the convoy.
Clause 95. The convoy system of any clause or example herein, in particular, any one of clauses 67-94, wherein the appliance further comprises an eye tracker system that monitors a gaze of a driver of the leader vehicle, and the controller is configured to guide the one or more first sensors, the one or more second sensors, or both the first and second sensors based on data from eye tracker system.
Clause 96. The convoy system of any clause or example herein, in particular, any one of clauses 67-95, wherein one, some, or all of the follower vehicles in the convoy are configured to relay information received from the appliance to subsequent vehicles in the convoy.
Clause 97. The convoy system of any clause or example herein, in particular, any one of clauses 67-96, wherein the controller is further configured to record a performance of a driver of the lead vehicle, performance of the convoy, a safety record of the lead vehicle or one or more follower vehicles, or any combination of the foregoing.
Clause 98. The convoy system of any clause or example herein, in particular, any one of clauses 67-97, wherein the controller is further configured to provide an alert to a driver of the lead vehicle regarding one or more hazards.
Clause 99. The convoy system of any clause or example herein, in particular, clause 98, wherein the one or more hazards comprises a lane departure, a collision warning, a traffic warning, an accident, a construction zone, or any combination of the foregoing.
Clause 100. The convoy system of any clause or example herein, in particular, any one of clauses 67-99, wherein the controller is further configured to store an archived map with the information based on the processed data.
Clause 101. The convoy system of any clause or example herein, in particular, any one of clauses 67-100, wherein at least one of the one or more follower vehicles is manually driven.
Clause 102. The convoy system of any clause or example herein, in particular, any one of clauses 67-101, wherein the information relayed to the one or more follower vehicles comprises a warning of an upcoming hazard.
Clause 103. The convoy system of any clause or example herein, in particular, any one of clauses 67-102, wherein the communication system is configured as a vehicle-to-infrastructure (V2I) system, and the information is sent to communication infrastructure in the environment for transmission to the one or more follower vehicles.
Clause 104. The convoy system of any clause or example herein, in particular, any one of clauses 67-103, wherein the one or more follower vehicles is configured to use the relayed information to improve fuel consumption.
Clause 105. The convoy system of any clause or example herein, in particular, any one of clauses 67-104, wherein the controller is configured to process the data to determine a condition of the road, and the relayed information includes the determined road condition.
Clause 106. The convoy system of any clause or example herein, in particular clause 105, wherein the determined road conditions comprises road crown, washboard or corrugation (e.g., periodic, transverse ripples in the surface of the road), washout (e.g., erosion of road surface), pothole, sinkhole, or any combination of the foregoing.
Clause 107. The convoy system of any clause or example herein, in particular, any one of clauses 67-106, wherein the controller is configured to determine a distance to each follower vehicle as measured from the leader vehicle.
Clause 108. The convoy system of any clause or example herein, in particular, any one of clauses 67-107, wherein the controller is configured to forward information regarding at least one of the follower vehicles to at least one other follower vehicle in the convoy.
Clause 109. The convoy system of any clause or example herein, in particular, any one of clauses 67-108, wherein the one or more first sensors, the one or more second sensors, or both the first and second sensors are configured to calibrate automatically based on an intrinsic parameter, an extrinsic parameter, or both intrinsic and extrinsic parameters.
Clause 110. The convoy system of any clause or example herein, in particular, any one of clauses 67-109, wherein the controller is further configured to relay telemetry information to a remote monitoring system.
Clause 111. The convoy system of any clause or example herein, in particular, clause 110, wherein the telemetry information comprises fuel consumption, battery state of charge, location of the leader vehicle and/or other vehicles in the convoy, trajectory of the leader vehicle and/or other vehicles in the convoy, elevation of the leader vehicle and/or other vehicles in the convoy, speed of the leader vehicle and/or other vehicles in the convoy, pitch of the leader vehicle and/or other vehicles in the convoy, identification number of the leader vehicle and/or other vehicles in the convoy, number of vehicles in the convoy, cargo of the leader vehicle and/or other vehicles in the convoy, or any combination of the foregoing.
Clause 112. The convoy system of any clause or example herein, in particular, any one of clauses 67-111, the controller is further configured to record a safety incident of the leader vehicle and/or other vehicles in the convoy.
Clause 113. The convoy system of any clause or example herein, in particular, clause 112, wherein the safety incident comprises a harsh braking incident, a collision, speed exceeding a limit, a driving infraction, a regulatory infraction, or any combination of the foregoing
Clause 114. The convoy system of any clause or example herein, in particular, any one of clauses 67-113, wherein the appliance is integrated into an automated driving system of the lead vehicle.

### VI. Rules of Interpretation

Throughout the description herein and unless otherwise specified, the following terms may include and/or encompass the example meanings provided. These terms and illustrative example meanings are provided to clarify the language selected to describe embodiments both in the specification and in the appended points of focus, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like. The term “computing” as utilized herein may generally refer to any number, sequence, and/or type of electronic processing activities performed by an electronic device, such as, but not limited to looking up (e.g., accessing a lookup table or array), calculating (e.g., utilizing multiple numeric values in accordance with a mathematic formula), deriving, and/or defining.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as ultra-wideband (UWB) radio, Bluetooth™, Wi-Fi, TDMA, CDMA, 3G, 4G, 4G LTE, 5G, etc.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

### VII. Conclusion

Any of the features illustrated or described with respect to FIGS. 1-4B and Clauses 1-114 can be combined with any other features illustrated or described with respect to FIGS. 1-4B and Clauses 1-114 to provide systems, modules, appliances, methods, devices, or embodiments not otherwise illustrated or specifically described herein. All features described herein are independent of one another and, except where structurally impossible, can be used in combination with any other feature described herein.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the present disclosure.

1. A convoy system comprising:
a convoy leader module for a leader vehicle of a convoy, the convoy leader module comprising:
a first suite of sensors, the first suite comprising at least one feature sensor operable to detect features or terrain in an environment to be traversed by the leader vehicle and at least one location sensor operable to determine a location of the leader vehicle;
a first communication system operable to transmit one or more signals between the leader vehicle and one or more follower vehicles in the convoy; and
a first controller operatively coupled to the first suite of sensors and the first communication system, the first controller comprising one or more first processors and first non-transitory computer readable storage media storing instructions that, when executed by the one or more first processors, cause the first controller to:
detect, via the at least one feature sensor, one or more features as the leader vehicle travels along a route through the environment;
detect, via the at least one location sensor, the route of the leader vehicle through the environment;
build, based at least in part on the detected one or more features and the detected route, a map for at least part of the environment with the detected route therethrough; and
transmit, via the first communication system, first data indicative of the map and the detected route to the one or more follower vehicles in the convoy.

2-6. (canceled)

7. The convoy system of claim 1, wherein the transmitted first data is descriptive of at least one lane marking, at least one lane width, at least one road sign, at least one road grade, at least one road condition, at least one road hazard, or any combination of the foregoing.

8. The convoy system of claim 1, further comprising a convoy follower module for an autonomous follower vehicle in the convoy, the convoy follower module comprising:
a second suite of sensors comprising at least one feature sensor operable to detect features in the environment to be traversed by the autonomous follower vehicle;
a second communication system operable to transmit one or more signals (i) between the autonomous follower vehicle and the leader vehicle, (ii) between the autonomous follower vehicle and other vehicles in the convoy, or (iii) both (i) and (ii); and
a second controller operatively coupled to the second suite of sensors and the second communication system, the second controller comprising one or more second processors and second non-transitory computer readable storage media storing instructions that, when executed by the one or more second processors, cause the second controller to:
receive, via the second communication system, the first data indicative of the map and the route;
detect, via the at least one feature sensor in the second suite of sensors, one or more features in the environment surrounding the autonomous follower vehicle; and
control, via a drive-by-wire kit, the autonomous follower vehicle to follow the route based at least in part on the first data and the detected one or more features.

9. The convoy system of claim 8, wherein:
the second suite of sensors further comprises at least one location sensor operable to determine a location of the autonomous follower vehicle,
the second non-transitory computer readable storage media stores additional instructions, that, when executed by the one or more second processors cause the second controller to detect, via the at least one location sensor, a location of the autonomous follower vehicle, and
the control of the autonomous follower vehicle to follow the route is based at least in part on the first data, the detected one or more features, and the detected location.

10. The convoy system of claim 1, wherein the first suite of sensors comprises at least one wheel odometry sensor, or the leader vehicle comprises at least one wheel odometry sensor.

11. The convoy system of claim 10, wherein:
the first non-transitory computer readable storage media stores additional instructions that, when executed by the one or more first processors, further cause the first controller to detect a slip condition of the leader vehicle based on a comparison of data from the at least one wheel odometry sensor and data from the at least one location sensor, and
the transmitted first data is further indicative of the slip condition and a location of the slip condition.

12. The convoy system of claim 11, further comprising a convoy follower module for an autonomous follower vehicle in the convoy, the convoy follower module comprising:
a second suite of sensors;
a second communication system operable to transmit one or more signals (i) between the autonomous follower vehicle and the leader vehicle, (ii) between the autonomous follower vehicle and other vehicles in the convoy, or (iii) both (i) and (ii); and
a second controller operatively coupled to the second suite of sensors and the second communication system, the second controller comprising one or more second processors and second non-transitory computer readable storage media storing instructions that, when executed by the one or more second processors, cause the second controller to:
receive, via the second communication system, the first data indicative of the map, the route, the slip condition, and the location of the slip condition;
control, via a drive-by-wire kit, the autonomous follower vehicle to follow the route based at least in part on the first data;
detect, via the second suite of sensors, a location of the autonomous follower vehicle approaching or matching the location of the slip condition; and
implement one or more remedial measures as the autonomous follower vehicle traverses the location of the slip condition.

13. The convoy system of claim 12, wherein the one or more remedial measures comprise:
determining location of the autonomous follower vehicle without use of wheel odometry data;
changing an error budget for use of wheel odometry data in determining location of the autonomous follower vehicle;
determining location of the autonomous follower vehicle by correlating a direction of detected error in wheel odometry with that from the leader vehicle;
avoiding acceleration, deceleration, or both while in the location of the slip condition;
changing a speed of the autonomous follower vehicle to reduce traction loss in the location of the slip condition;
changing a distance between vehicles in the convoy;
allowing greater deviations of the autonomous follower vehicle from the route in the location of the slip condition;
changing an inflation state of one or more tires of the autonomous follower vehicle; or
any combination of the above.

14. The convoy system of claim 1, wherein the leader vehicle comprises a plurality of wheel encoders, each wheel encoder being associated with a respective wheel of the leader vehicle.

15. The convoy system of claim 14, wherein:
the first non-transitory computer readable storage media stores additional instructions that, when executed by the one or more first processors, further cause the first controller to detect a slip condition of the leader vehicle based on a comparison of data from the plurality of wheel encoders, and
the transmitted first data is further indicative of the slip condition and a location of the slip condition.

16. The convoy system of claim 15, further comprising a convoy follower module for an autonomous follower vehicle in the convoy, the convoy follower module comprising:
a second suite of sensors;
a second communication system operable to transmit one or more signals (i) between the autonomous follower vehicle and the leader vehicle, (ii) between the autonomous follower vehicle and other vehicles in the convoy, or (iii) both (i) and (ii); and
a second controller operatively coupled to the second suite of sensors and the second communication system, the second controller comprising one or more second processors and second non-transitory computer readable storage media storing instructions that, when executed by the one or more second processors, cause the second controller to:
receive, via the second communication system, the first data indicative of the map, the route, the slip condition, and the location of the slip condition;
control, via a drive-by-wire kit, the autonomous follower vehicle to follow the route based at least in part on the first data;
detect, via the second suite of sensors, a location of the autonomous follower vehicle approaching or matching the location of the slip condition; and
implement one or more remedial measures as the autonomous follower vehicle traverses the location of the slip condition.

17. The convoy system of claim 16, wherein the one or more remedial measures comprise:
determining location of the autonomous follower vehicle without use of wheel odometry data;
changing an error budget for use of wheel odometry data in determining location of the autonomous follower vehicle;
determining location of the autonomous follower vehicle by correlating a direction of detected error in wheel odometry with that from the leader vehicle;
avoiding acceleration, deceleration, or both while in the location of the slip condition;
changing a speed of the autonomous follower vehicle to reduce traction loss in the location of the slip condition;
changing a distance between vehicles in the convoy;
allowing greater deviations of the autonomous follower vehicle from the route in the location of the slip condition;
changing an inflation state of one or more tires of the autonomous follower vehicle; or
any combination of the above.

18. The convoy system of claim 1, wherein:
the first non-transitory computer readable storage media stores additional instructions that, when executed by the one or more first processors, further cause the first controller to classify a terrain of the route through the environment, and
the transmitted first data is further indicative of the classified terrain.

19. The convoy system of claim 18, wherein:
the first suite of sensors comprises a strain gauge, an accelerometer, or both a strain gauge and accelerometer, and
the first controller classifies the terrain based at least in part on data from the strain gauge, the accelerometer, or both the strain gauge and the accelerometer.

20-30. (canceled)

31. A convoy comprising:
(a) a leader vehicle comprising:
a first suite of sensors, the first suite comprising at least one feature sensor operable to detect features or terrain in an environment to be traversed by the leader vehicle and at least one location sensor operable to determine a location of the leader vehicle;
a first communication system operable to transmit one or more signals between the leader vehicle and one or more follower vehicles in the convoy; and
a first controller operatively coupled to the first suite of sensors and the first communication system, the first controller comprising one or more first processors and first non-transitory computer readable storage media storing instructions that, when executed by the one or more first processors, cause the first controller to:
detect, via the at least one feature sensor, one or more features as the leader vehicle travels along a route through the environment;
detect, via the at least one location sensor, the route of the leader vehicle through the environment;
build, based at least in part on the detected one or more features and the detected route, a map for at least part of the environment with the detected route therethrough; and
transmit, via the first communication system, first data indicative of the map and the detected route to the one or more follower vehicles in the convoy; and
(b) a plurality of autonomous follower vehicles for following the leader vehicle in the convoy, each autonomous follower vehicle comprising:
a drive-by-wire kit;
a second suite of sensors;
a second communication system operable to transmit one or more signals between the plurality of autonomous follower vehicles, the leader vehicle, or both; and
a second controller operatively coupled to the second suite of sensors and the second communication system, the second controller comprising one or more second processors and second non-transitory computer readable storage media storing instructions that, when executed by the one or more second processors, cause the second controller to:
receive, via the second communication system, the first data; and
control, via the drive-by-wire kit, the respective autonomous follower vehicle to follow the route based at least in part on the first data.

32. (canceled)

33. The convoy of claim 31, wherein:
the second non-transitory computer readable storage media stores additional instructions that, when executed by the one or more second processors cause the second controller to detect, via the second suite of sensors, one or more features in the environment surrounding the autonomous follower vehicle, and
the respective autonomous follower vehicle is controlled to follow the route based at least in part on the first data and the detected one or more features.

34. The convoy of claim 31, wherein:
the first non-transitory computer readable storage media stores additional instructions that, when executed by the one or more first processors, further cause the first controller to detect a slip condition of the leader vehicle based on (a) a comparison of data from at least one wheel odometry sensor and data from the at least one location sensor, (b) a comparison of data from a plurality of wheel encoders, or (c) both (a) and (b);
the transmitted first data is further indicative of the slip condition and a location of the slip condition; and
the second non-transitory computer readable storage media stores additional instructions that, when executed by the one or more second processors cause the second controller to:
detect, via the second suite of sensors, a location of the autonomous follower vehicle approaching or matching the location of the slip condition; and
implement one or more remedial measures as the autonomous follower vehicle traverses the location of the slip condition.

35. The convoy of claim 34, wherein the one or more remedial measures comprise:
determining location of the autonomous follower vehicle without use of wheel odometry data;
changing an error budget for use of wheel odometry data in determining location of the autonomous follower vehicle;
determining location of the autonomous follower vehicle by correlating a direction of detected error in wheel odometry with that from the leader vehicle;
avoiding acceleration, deceleration, or both while in the location of the slip condition;
changing a speed of the autonomous follower vehicle to reduce traction loss in the location of the slip condition;
changing a distance between vehicles in the convoy;
allowing greater deviations of the autonomous follower vehicle from the route in the location of the slip condition;
changing an inflation state of one or more tires of the autonomous follower vehicle; or
any combination of the above.

36. (canceled)

37. The convoy of claim 31, wherein:
the first non-transitory computer readable storage media stores additional instructions that, when executed by the one or more first processors, further cause the first controller to detect, via the first suite of sensors, an environmental aspect in or along the route and a location of the environmental aspect;
the transmitted first data is further indicative of the environmental aspect and the location of the environmental aspect; and
the second non-transitory computer readable storage media stores additional instructions that, when executed by the one or more second processors cause the second controller to:
detect, via the second suite of sensors, a location of the autonomous follower vehicle approaching or matching the location of the environmental aspect; and
implement one or more remedial measures as the autonomous follower vehicle traverses the location of the environmental aspect.

38. The convoy of claim 37, wherein:
(i) the environmental aspect comprises a dust cloud, an area susceptible to dust production, road crown, roadway corrugation, roadway washout, pothole, sinkhole, deformable features in roadway, puddle, mud, or any combination of the foregoing;
(ii) the one or more remedial measures comprise:
changing an acceleration/deceleration profile available for autonomous follower vehicle;
changing a speed of the autonomous follower vehicle;
changing a distance between vehicles in the convoy; or
any combination of the above; or
(iii) both (i) and (ii).

39-46. (canceled)
